(19) United States
(12) Patent Application Publication
(10) Pub. No.: US 2008/0233410 A1
(43) Pub. Date: Sep. 25, 2008

(54) Transition metal complex compound

(75) Inventors: Kazushi Mashima, Osaka (JP); Masami Watanabe, Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignees: Idemitsu Kosan Co., Ltd., Chiyoda-ku (JP); Osaka University, Suita-shi (JP)

(21) Appl. No.: 11/516,759

(22) Filed: Sep. 7, 2006

(30) Foreign Application Priority Data
Nov. 17, 2005 (JP) 2005-332543
Jun. 26, 2006 (JP) 2006-175904

(51) Int. Cl. B32B 9/00; C07F 15/00

(52) U.S. Cl. 428/457; 548/108

(57) ABSTRACT

The present invention provides a transition metal complex compound of a specific structure having a metal carbene bond, a production process for the same and an organic EL device in which an organic thin film layer comprising a single layer or plural layers having at least a luminescent layer is interposed between an anode and a cathode, wherein at least one layer in the above organic thin film layers contains the transition metal complex compound having a metal carbene bond described above. Provided are a novel transition metal complex compound having a metal carbene bond which has an electroluminescent characteristic and which can provide an organic electroluminescent device having a high luminous efficiency and a production process for a transition metal complex compound.

### BACKGROUND OF THE INVENTION

The present invention relates to a transition metal complex compound, specifically to a transition metal complex compound having an electroluminescent characteristic which can provide an organic electroluminescent device having a high luminous efficiency and a production process for the transition metal complex compound.

### RELATED ART

An organic electroluminescent (EL) device is a spontaneous luminescent device making use of the principle that a fluorescent substance emits light by recombination energy of holes injected from an anode and electrons injected from a cathode by applying an electric field. Since a low voltage-driven organic EL device of a laminate type was reported by C. W. Tang et al. of Eastman Kodak Company (C. W. Tang and S. A. Vanslyke, Applied Physics Letters, Vol. 51, p. 913, 1987), researches on organic EL devices comprising organic materials as structural materials have actively been carried out. Tang et al. use tris(8-hydroxyquinolinolaluminum) for the luminescent layer and a triphenyldiamine derivative for the hole transporting layer. The advantages of a laminate structure include an elevation in an efficiency of injecting holes into a luminescent layer, a rise in a forming efficiency of excitons formed by blocking electrons injected from a cathode to recombine them and shutting up of excitons formed in the luminescent layer. As shown in the above example, a two layer type comprising a hole transporting (injecting) layer and an electron transporting and luminescent layer and a three layer type comprising a hole transporting (injecting) layer, a luminescent layer and an electron transporting (injecting) layer are well known as the device structures of the organic EL device. In such laminate type structural devices, device structures and forming methods are studied in order to enhance a recombination efficiency of holes and electrons injected.

Known as luminescent materials for an organic EL device are luminescent materials such as chelate complexes including a tris(8-quinolinolate)aluminum complex, coumarin derivatives, tetraphenylbutadiene derivatives, bisstyrylarylene derivatives and oxadiazole derivatives. It is reported that emission of a blue color to a red color in a visible region is obtained from them, and it is expected that a color display device is materialized (refer to, for example, a patent document 1).

In recent years, it is proposed as well to make use of organic phosphorescent materials in addition to luminescent materials for a luminescent layer in an organic EL device (refer to, for example, a non-patent document 1 and a non-patent document 2). As described above, a singlet state and a triplet state in an excited state of a phosphorescent material are utilized in a luminescent layer of an organic EL device, whereby a high luminous efficiency is achieved. It is considered that a singlet exciton and a triplet exciton are produced in a proportion of 1:3 due to a difference in a spin multiplicity when an electron and a hole are recombined in an organic EL device, and therefore it is considered that a luminous efficiency which is larger by 3 to 4 times than that of a device using only a fluorescent material is achieved if a phosphorescent luminescent material is used.

In such organic EL device, there has been used a constitution in which layers are laminated in such an order as an anode, a hole transporting layer, an organic luminescent layer, an electron transporting layer (hole blocking layer), an electron transporting layer and a cathode so that a triplet excited state or a triplet exciton is not quenched, and a host compound and a phosphorescent material have been used for an organic luminescent layer (refer to, for example, a patent document 2 and a patent document 3).

The above patent documents relate to technologies on phosphorescent materials emitting red to green lights. Further, technologies on luminescent materials having a blue color base luminescent color are disclosed as well (refer to, for example, a patent document 4, a patent document 5 and a patent document 6). However, they have a very short device life. In particular, skeleton structures of ligands in which Ir metal is bonded to a phosphorus atom are described in the patent document 5 and the patent document 6, and while they emit blued light, they have weak bonding and are markedly poor in a heat resistance. A complex in which an oxygen atom and a nitrogen atom are bonded to central metal is described in a patent document 7. However, a specific effect of a group bonded to an oxygen atom is not described and uncertain. A complex in which nitrogen atoms contained in different cyclic structures each are bonded to central metal is disclosed in a patent document 8, and a device prepared by making use of it exhibits as small external quantum efficiency as about 5% though blue light is emitted.

On the other hand, transition metal complex compounds having a metal carbene bond (hereinafter referred to as a carbene complex) are researched in recent years (refer to, for example, a patent document 9 and non-patent documents 3 to 11).

Carbene means two-coordinate carbon which has two electrons in an sp² hybrid orbit and a 2p orbit, and it can assume four kinds of structures depending on combinations of the orbits in which two electrons are present and the direction of spin. Usually, it is singlet carbene and comprises an occupied orbit of sp² hybrid and an empty 2p orbit.

A carbene complex has a short life and is instable, and it has so far been utilized as a reaction intermediate in organic synthetic reaction or a conversion reagent for addition to olefin. In 1991, stable carbene complexes comprising an aromatic heterocyclic structure and stable carbene complexes comprising a non-aromatic cyclic structure were found out, and thereafter, non-cyclic carbene complexes came to be stably obtained by stabilizing them with nitrogen and phosphorus. A catalytic performance is enhanced by using them as a ligand to bond them to transition metals, and therefore in recent years, expectation to stable carbene complexes grows high in catalytic reaction in organic synthesis.

It is found that particularly in olefin metathesis reaction, the performances are notably enhanced by adding or coordinating stable carbene complexes. Further, in recent years, developed are researches on the efficiency of Suzuki coupling reaction, oxidation of alkanes, selective hydroformylation reaction and optically active carbene complexes, and application of carbene complexes to the organic synthetic field attracts attentions.

The examples of complexes specifically having a carbene iridium bond are described in the following non-patent document 12 (a tris(carbene)iridium complex comprising a non-heterocyclic type carbene ligand) and non-patent document 13 (unidentate coordination type monocarbene iridium complex), but applications thereof to the organic EL device field and the like are not described.

Further, synthesis of iridium complexes having a carbene bond, an emission wavelength thereof and the performances of the device are described in the patent document 9, but the energy efficiency and the external quantum efficiency are low. In addition thereto, the emission wavelength is distributed in a ultraviolet area, and the visual efficiency is inferior. Accordingly, they are not suited to light emitting devices in a visual wavelength region such as organic EL. They can not be vacuum-deposited because of a low decomposition temperature and a high molecular weight, and the complexes are decomposed in deposition, so that a problem is involved in the point that impurities are mixed in producing the devices.

Patent document 1: Japanese Patent Application Laid-Open No. 239655/1996
Patent document 2: U.S. Pat. No. 6,097,147
Patent document 3: International Publication No. WO01/41512
Patent document 4: US 2001/0025108
Patent document 5: US 2002/0182441
Patent document 6: Japanese Patent Application Laid-Open No. 170684/2002
Patent document 7: Japanese Patent Application Laid-Open No. 123982/2003
Patent document 8: Japanese Patent Application Laid-Open No. 133074/2003
Patent document 9: International Publication No. WO05/019373
Non-patent document 1: D. F. OBrien and M. A. Baldo et al. “Improved energy transfer in electrophosphorescent devices”, Applied Physics Letters, Vol. 74, No. 3, pp. 442 to 444, Jan. 18, 1999
Non-patent document 2: M. A. Baldo et al. “Very high-efficiency green organic light-emitting devices based on electrophosphorescence”, Applied Physics Letters, Vol. 75, No. 1, pp. 4 to 6, Jul. 5, 1999
Non-patent document 3: Chem. Rev., 2000, 100, p. 39
Non-patent document 4: J. Am. Chem. Soc., 1991, 113, p. 361
Non-patent document 5: Angew. Chem. Int. Ed., 2002, 41, p. 1290
Non-patent document 6: J. Am. Chem. Soc., 1999, 121, p. 2674
Non-patent document 7: Organometallics, 1999, 18, p. 2370
Non-patent document 8: Angew. Chem. Int. Ed., 2002, 41, p. 1363
Non-patent document 9: Angew. Chem. Int. Ed., 2002, 41, p. 1745
Non-patent document 10: Organometallics, 2000, 19, p. 3459
Non-patent document 11: Tetrahedron Asymmetry, 2003, 14, p. 951
Non-patent document 12: Organomet. Chem., 1982, 239, 14, C26 to C30
Non-patent document 13: Chem. Commun., 2002, p. 2518

### DISCLOSURE OF THE INVENTION

The present invention has been made in order to solve the problems described above, and an object thereof is to provide a novel transition metal complex compound which materializes an organic EL device having a high luminous efficiency and a production process for the transition metal compound.

Intensive researches repeated by the present inventors in order to achieve the object described above have resulted in finding that an organic EL device having a high luminous efficiency is obtained by using a transition metal complex compound of a specific structure having a metal carbene bond represented by the following Formula (1), and they have come to complete the present invention.

That is, the present invention provides a transition metal complex compound having a metal carbene bond represented by the following Formulas (1), (3) and (4):

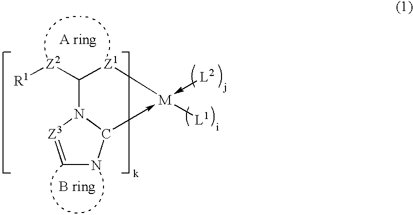

[in Formula (1), C (carbon atom)→M represents a metal carbene bond; a bond shown by a solid line (—) represents a covalent bond; a bond shown by an arrow (→) represents a coordinate bond; M represents a metal atom of iridium (Ir), platinum (Pt), rhodium (Rh) or palladium (Pd); L¹ and L² each represent independently a unidentate ligand or a cross-linked bidentate ligand (L¹-L²) in which L¹ is cross-linked with L²; k represents an integer of 1 to 3, and i represents an integer of 0 to 2; k+i represents a valence of metal M; j represents an integer of 0 to 4; when i and j are plural, L¹ and L² may be the same as or different from each other, and the adjacent ligands may be cross-linked with each other;
L¹ represents a monovalent aromatic hydrocarbon group having 6 to 30 nuclear carbon atoms which may have a substituent, a monovalent heterocyclic group having 3 to 30 nuclear carbon atoms which may have a substituent, a monovalent carboxyl-containing group having 1 to 30 carbon atoms which may have a substituent, a monovalent amino group or hydroxyl group-containing hydrocarbon group which may have a substituent, a cycloalkyl group having 3 to 50 nuclear carbon atoms which may have a substituent, an alkyl group having 1 to 30 carbon atoms which may have a substituent, an alkenyl group having 2 to 30 carbon atoms which may have a substituent or an aralkyl group having 7 to 40 carbon atoms which may have a substituent, and when L¹ is cross-linked with L², it is a divalent group of each ligand described above;
L² represents a ligand comprising a heterocycle having 3 to 30 nuclear carbon atoms which may have a substituent, carboxylic acid ester having. 1 to 30 carbon atoms which may have a substituent, carboxylic amide having 1 to 30 carbon atoms, amine which may have a substituent, phosphine which may have a substituent, isonitrile which may have a substituent, ether having 1 to 30 carbon atoms which may have a substituent, thioether having 1 to 30 carbon atoms which may have a substituent or a double bond-containing compound having 1 to 30 carbon atoms which may have a substituent, and when L¹ is cross-linked with L², it is a monovalent group of each ligand described above;
Z¹ represents an atom forming a covalent bond with metal M, and it is a carbon, silicon, nitrogen or phosphorus atom;
Z² represents an atom forming a covalent bond with a substituent R¹, and it is a carbon, silicon, nitrogen or phosphorus atom; an A ring containing Z¹ and Z² and a B ring represent an aromatic hydrocarbon group having 3 to 40 nuclear carbon atoms which may have a substituent or a heterocyclic group having 3 to 40 nuclear carbon atoms which may have a substituent; Z³ represents a nitrogen atom or CR², and when CR² is plural, plural R² may be the same or different;
R¹ and R² each represent independently a hydrogen atom, a halogen atom, a thiocyano group or a cyano group, a nitro group, a —S(═O)₂R¹⁸ group or a —S(═O)R¹⁸ group, an alkyl group having 1 to 30 carbon atoms which may have a substituent, a halogenated alkyl group having 1 to 30 carbon atoms which may have a substituent, an aromatic hydrocarbon group having 6 to 30 nuclear carbon atoms which may have a substituent, a cycloalkyl group having 3 to 30 nuclear carbon atoms which may have a substituent, an aralkyl group having 7 to 40 carbon atoms which may have a substituent, an alkenyl group having 2 to 30 carbon atoms which may have a substituent, a heterocyclic group having 3 to 30 nuclear carbon atoms which may have a substituent, an alkoxy group having 1 to 30 carbon atoms which may have a substituent, an aryloxy group having 6 to 30 nuclear carbon atoms which may have a substituent, an alkylamino group having 3 to 30 nuclear carbon atoms which may have a substituent, an arylamino group having 6 to 30 carbon atoms which may have a substituent, an alkylsilyl group having 3 to 30 nuclear carbon atoms which may have a substituent, an arylsilyl group having 6 to 30 carbon atoms which may have a substituent or a carboxyl-containing group having 1 to 30 carbon atoms, and when Z³ is CR², R¹ may be cross-linked with R²;
(R¹⁸ each represents independently a hydrogen atom, an alkyl group having 1 to 30 carbon atoms which may have a substituent, a halogenated alkyl group having 1 to 30 carbon atoms which may have a substituent, an aromatic hydrocarbon group having 6 to 30 nuclear carbon atoms which may have a substituent, a cycloalkyl group having 3 to 50 nuclear carbon atoms which may have a substituent, an aralkyl group having 7 to 40 carbon atoms which may have a substituent, an alkenyl group having 2 to 30 carbon atoms which may have a substituent, a heterocyclic group having 3 to 30 nuclear carbon atoms which may have a substituent, an alkoxy group having 1 to 30 carbon atoms which may have a substituent, an aryloxy group having 6 to 30 nuclear carbon atoms which may have a substituent, an alkylamino group having 3 to 30 carbon atoms which may have a substituent, an arylamino group having 6 to 30 carbon atoms which may have a substituent, an alkylsilyl group having 3 to 30 carbon atoms which may have a substituent, an arylsilyl group having 6 to 30 carbon atoms which may have a substituent or a carboxyl-containing group having 1 to 30 carbon atoms which may have a substituent); when k is plural, Z¹, Z², Z³, R¹, the A ring and the B ring may be the same as or different from each other and may be cross-linked with adjacent ones];

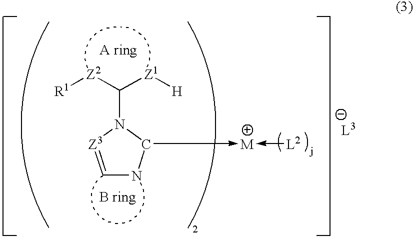

[in Formula (3), C (carbon atom)→M represents a metal carbene bond; a bond shown by an arrow represents a coordinate bond; M is the same as described above; L² represents a unidentate ligand; j is the same as described above; when j is plural, respective L² may be the same as or different from each other and may be cross-linked; L² is the same ligand as described above; L³ represents a conjugated base of superstrong acids having a pKa value of −10 or less, carboxylic acids, aldehydes, ketones, alcohols, thioalcohols, phenols, amines, amides, aromatics or alkanes, a hydrogen ion or a halide ion;
Z¹ represents a carbon, silicon, nitrogen or phosphorus atom, and Z², Z³ and R¹ each are the same as described above; Z¹, Z², Z³, R¹, an A ring and a B ring which are two respectively may be the same as or different from each other and may be cross-linked with adjacent ones];

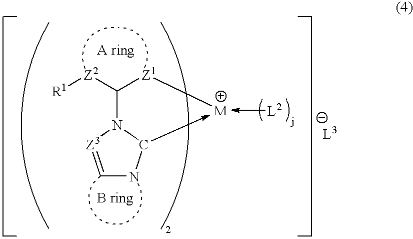

[in Formula (4), C (carbon atom)→M represents a metal carbene bond; a bond shown by a solid line (—) represents a covalent bond; a bond shown by an arrow (→) represents a coordinate bond; M is the same as described above; L² represents a unidentate ligand; j is the same as described above; when j is plural, respective L² may be the same as or different from each other and may be cross-linked; L² is the same ligand as described above, and L³, Z¹, Z², Z³ and R¹ each are the same as described above; Z¹, Z², Z³, R¹, an A ring and a B ring which are two respectively may be the same as or different from each other and may be cross-linked with adjacent ones].

Further, the present invention provides a production process for a transition metal compound having a metal carbene bond in which an iridium compound represented by the following Formula (5) is reacted with an imidazolium salt represented by the following Formula (6) in the presence of a solvent and a base to produce a transition metal compound represented by the following Formula (7):

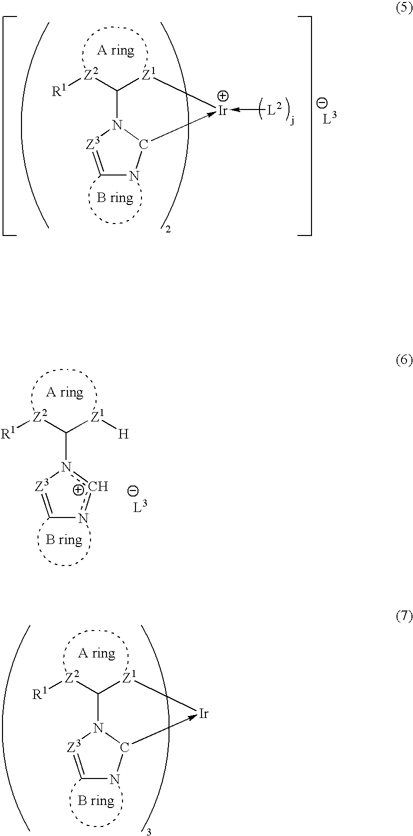

[in Formulas (5) to (7), C (carbon atom)→Ir (iridium) represents a metal carbene bond; a bond shown by a solid line (—) represents a covalent bond; a bond shown by an arrow (→) represents a coordinate bond; L² represents a unidentate ligand; j is the same as described above; when j is plural, respective L² may be the same as or different from each other and may be cross-linked;
L² is the same ligand as described above, and L³, Z¹, Z², Z³ and R¹ each are the same as described above;
Z¹, Z², Z³, R¹, an A ring and a B ring which are two respectively may be the same as or different from each other and may be cross-linked with adjacent ones].

Further, the present invention provides an organic EL device in which an organic thin film layer comprising a single layer or plural layers having at least a luminescent layer is interposed between an anode and a cathode, wherein at least one layer in the above organic thin film layer contains the transition metal compound having a metal carbene bond described above.

The transition metal compound of the present invention having a metal carbene bond has an electroluminescent characteristic and can provide an organic EL device having a high luminous efficiency. Further, according to the production process of the present invention for a transition metal complex compound, the transition metal complex compound can efficiently be produced.

### BRIEF DESCRIPTIONS OF THE DRAWINGS

FIG. 1 is a diagram showing a ¹H-NMR spectrum of an intermediate c obtained in Example 1.

FIG. 2 is a diagram showing a ¹H-NMR spectrum of an intermediate d obtained in Example 1.

FIG. 3 is a diagram showing a ¹H-NMR spectrum of a transition metal complex compound 1 obtained in Example 1.

FIG. 4 is a diagram showing a ¹H-NMR spectrum of a transition metal complex compound 1 obtained in Example 2.

FIG. 5 is a diagram showing a cyclic voltammetry of a transition metal complex compound 1 obtained in Example 3.

FIG. 6 is a diagram showing an X-ray crystal structure analysis of the transition metal complex compound 1 obtained in Example 3.

FIG. 7 is a diagram showing a ¹H-NMR spectrum of a transition metal complex compound 2 obtained in Example 4.

FIG. 8 is a diagram showing a cyclic voltammetry of a transition metal complex compound 1 obtained in Example 4.

FIG. 9 is a diagram showing an X-ray crystal structure analysis of the transition metal complex compound 2 obtained in Example 4.

### BEST MODE FOR CARRYING OUT THE INVENTION

The transition metal complex compound of the present invention is a transition metal complex compound having a metal carbene bond represented by the following Formulas (1), (3) and (4).

Formula (1) shall be explained below.

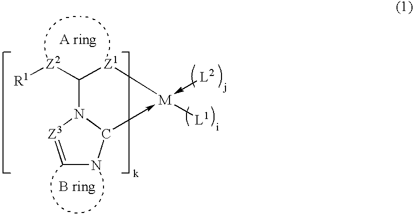

In Formula (1), C (carbon atom)→M represents a metal carbene bond; a bond shown by a solid line (—) represents a covalent bond; a bond shown by an arrow (→) represents a coordinate bond.

In Formula (1), M represents a metal atom of iridium (Ir), platinum (Pt), rhodium (Rh) or palladium (Pd), and Ir is preferred.

In Formula (1), L¹ and L² each represent independently a unidentate ligand or a cross-linked bidentate ligand (L¹-L²) in which L¹ is cross-linked with L²; k represents an integer of 1 to 3, and i represents an integer of 0 to 2; k+i represents a valence of metal M; j represents an integer of 0 to 4; when i and j are plural, L¹ and L² may be the same as or different from each other, and the adjacent ligands may be cross-linked with each other.

In Formula (1), L¹ represents a monovalent aromatic hydrocarbon group having 6 to 30 nuclear carbon atoms which may have a substituent, a monovalent heterocyclic group having 3 to 30 nuclear carbon atoms which may have a substituent, a monovalent carboxyl-containing group having 1 to 30 carbon atoms which may have a substituent, a monovalent amino group or hydroxyl group-containing hydrocarbon group which may have a substituent, a cycloalkyl group having 3 to 50 nuclear carbon atoms which may have a substituent, an alkyl group having 1 to 30 carbon atoms which may have a substituent, an alkenyl group having 2 to 30 carbon atoms which may have a substituent or an aralkyl group having 7 to 40 carbon atoms which may have a substituent, and when L¹ is cross-linked with L², it is a divalent group of each ligand described above.

The aromatic hydrocarbon group described above has preferably 6 to 18 nuclear carbon atoms and includes, for example, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, 1-naphthacenyl, 2-naphthacenyl, 9-naphthacenyl, 1-pyrenyl, 2-pyrenyl, 4-pyrenyl, 2-biphenylyl, 3-biphenylyl, 4-biphenylyl, p-terphenyl-4-yl, p-terphenyl-3-yl, p-terphenyl-2-yl, m-terphenyl-4-yl, m-terphenyl-3-yl, m-terphenyl-2-yl, o-tolyl, m-tolyl, p-tolyl, p-t-butylphenyl, p-(2-phenylpropyl)phenyl, 3-methyl-2-naphthyl, 4-methyl-1-naphthyl, 4-methyl-1-anthryl, 4′-methylbiphenylyl, 4″-t-butyl-p-terphenyl-4-yl, o-cumenyl, m-cumenyl, p-cumenyl, 2,3-xylylenyl, 3,4-xylylenyl, 2,5-xylylenyl, mesitylenyl, perfluorophenyl and groups obtained by converting the above groups into divalent groups.

Among them, preferred are phenyl, 1-naphthyl, 2-naphthyl, 9-phenanthryl, 2-biphenylyl, 3-biphenylyl, 4-biphenylyl, p-tolyl, 3,4-xylylenyl and groups obtained by converting the above groups into divalent groups.

The heterocyclic group described above has preferably 3 to 18 nuclear carbon atoms and includes, for example, 1-pyrrolyl, 2-pyrrolyl, 3-pyrrolyl, pyrazinyl, 2-pyridinyl, 1-imidazolyl, 2-imidazolyl, 1-pyrazolyl, 1-indolidinyl, 2-indolidinyl, 3-indolidinyl, 5-indolidinyl, 6-indolidinyl, 7-indolidinyl g, 8-indolidinyl, 2-imidazopyridinyl, 3-imidazopyridinyl, 5-imidazopyridinyl, 6-imidazopyridinyl, 7-imidazopyridinyl, 8-imidazopyridinyl, 3-pyridinyl, 4-pyridinyl, 1-indolyl, 2-indolyl, 3-indolyl, 4-indolyl, 5-indolyl, 6-indolyl, 7-indolyl, 1-isoindolyl, 2-isoindolyl, 3-isoindolyl, 4-isoindolyl, 5-isoindolyl, 6-isoindolyl, 7-isoindolyl, 2-furyl, 3-furyl, 2-benzofuranyl, 3-benzofuranyl, 4-benzofuranyl, 5-benzofuranyl, 6-benzofuranyl, 7-benzofuranyl, 1-isobenzofuranyl, 3-isobenzofuranyl, 4-isobenzofuranyl, 5-isobenzofuranyl, 6-isobenzofuranyl, 7-isobenzofuranyl, 2-quinolyl, 3-quinolyl, 4-quinolyl, 5-quinolyl, 6-quinolyl, 7-quinolyl, 8-quinolyl, 1-isoquinolyl, 3-isoquinolyl, 4-isoquinolyl, 5-isoquinolyl, 6-isoquinolyl, 7-isoquinolyl, 8-isoquinolyl, 2-quinoxalinyl, 5-quinoxalinyl, 6-quinoxalinyl, 1-carbazolyl, 2-carbazolyl, 3-carbazolyl, 4-carbazolyl, 9-carbazolyl, β-carboline-1-yl, β-carboline-3-yl, β-carboline-4-yl, β-carboline-5-yl, β-carboline-6-yl, β-carboline-7-yl, β-carboline-8-yl, β-carboline-9-yl, 1-phenanthridinyl, 2-phenanthridinyl, 3-phenanthridinyl, 4-phenanthridinyl, 6-phenanthridinyl, 7-phenanthridinyl, 8-phenanthridinyl, 9-phenanthridinyl, 10-phenanthridinyl, 1-acridinyl, 2-acridinyl, 3-acridinyl, 4-acridinyl, 9-acridinyl, 1,7-phenanthroline-2-yl, 1,7-phenanthroline-3-yl, 1,7-phenanthroline-4-yl, 1,7-phenanthroline-5-yl, 1,7-phenanthroline-6-yl, 1,7-phenanthroline-8-yl, 1,7-phenanthroline-9-yl, 1,7-phenanthroline-10-yl, 1,8-phenanthroline-2-yl, 1,8-phenanthroline-3-yl, 1,8-phenanthroline-4-yl, 1,8-phenanthroline-5-yl, 1,8-phenanthroline-6-yl, 1,8-phenanthroline-7-yl, 1,8-phenanthroline-9-yl, 1,8-phenanthroline-10-yl, 1,9-phenanthroline-2-yl, 1,9-phenanthroline-3-yl, 1,9-phenanthroline-4-yl, 1,9-phenanthroline-5-yl, 1,9-phenanthroline-6-yl, 1,9-phenanthroline-7-yl, 1,9-phenanthroline-8-yl, 1,9-phenanthroline-10-yl, 1,10-phenanthroline-2-yl, 1,10-phenanthroline-3-yl, 1,10-phenanthroline-4-yl, 1,10-phenanthroline-5-yl, 2,9-phenanthroline-1-yl, 2,9-phenanthroline-3-yl, 2,9-phenanthroline-4-yl, 2,9-phenanthroline-5-yl, 2,9-phenanthroline-6-yl, 2,9-phenanthroline-7-yl, 2,9-phenanthroline-8-yl, 2,9-phenanthroline-10-yl, 2,8-phenanthroline-1-yl, 2,8-phenanthroline-3-yl, 2,8-phenanthroline-4-yl, 2,8-phenanthroline-5-yl, 2,8-phenanthroline-6-yl, 2,8-phenanthroline-7-yl, 2,8-phenanthroline-9-yl, 2,8-phenanthroline-10-yl, 2,7-phenanthroline-1-yl, 2,7-phenanthroline-3-yl, 2,7-phenanthroline-4-yl, 2,7-phenanthroline-5-yl, 2,7-phenanthroline-6-yl, 2,7-phenanthroline-8-yl, 2,7-phenanthroline-9-yl, 2,7-phenanthroline-10-yl, 1-phenazinyl, 2-phenazinyl, 1-phenothiazinyl, 2-phenothiazinyl, 3-phenothiazinyl, 4-phenothiazinyl, 10-phenothiazinyl, 1-phenoxazinyl, 2-phenoxazinyl, 3-phenoxazinyl, 4-phenoxazinyl, 10-phenoxazinyl, 2-oxazolyl, 4-oxazolyl, 5-oxazolyl, 2-oxadiazolyl, 5-oxadiazolyl, 3-furazanyl, 2-thienyl, 3-thienyl, 2-methylpyrrole-1-yl, 2-methylpyrrole-3-yl, 2-methylpyrrole-4-yl, 2-methylpyrrole-5-yl, 3-methylpyrrole-1-yl, 3-methylpyrrole-2-yl, 3-methylpyrrole-4-yl, 3-methylpyrrole-5-yl, 2-t-butylpyrrole-4-yl, 3-(2-phenylpropyl)pyrrole-1-yl, 2-methyl-1-indolyl, 4-methyl-1-indolyl, 2-methyl-3-indolyl, 4-methyl-3-indolyl, 2-t-butyl-1-indolyl, 4-t-butyl-1-indolyl, 2-t-butyl-3-indolyl, 4-t-butyl-3-indolyl, pyrrolidine, pyrazolidine, piperazine and groups obtained by converting the above groups into divalent groups.

Among them, preferred are 2-pyridinyl, 1-indolidinyl, 2-indolidinyl, 3-indolidinyl, 5-indolidinyl, 6-indolidinyl, 7-indolidinyl, 8-indolidinyl, 2-imidazopyridinyl, 3-imidazopyridinyl, 5-imidazopyridinyl, 6-imidazopyridinyl, 7-imidazopyridinyl, 8-imidazopyridinyl, 3-pyridinyl, 4-pyridinyl, 1-indolyl, 2-indolyl, 3-indolyl, 4-indolyl, 5-indolyl, 6-indolyl, 7-indolyl, 1-isoindolyl, 2-isoindolyl, 3-isoindolyl, 4-isoindolyl, 5-isoindolyl, 6-isoindolyl, 7-isoindolyl, 1-carbazolyl, 2-carbazolyl, 3-carbazolyl, 4-carbazolyl, 9-carbazolyl and groups obtained by converting the above groups into divalent groups.

The carboxyl-containing group described above includes, for example, an ester bond (—C(═O)O—), methyl ester, ethyl ester, butyl ester and groups obtained by converting the above groups into divalent groups.

The cycloalkyl group and the cycloalkylene group each described above include, for example, cyclopropyl, cyclobutyl, cyclopentyl, cyclohexyl, 4-methylcyclohexyl, 1-adamantyl, 2-adamantyl, 1-norbornyl, 2-norbornyl and groups obtained by converting the above groups into divalent groups.

The alkyl group and the alkylene group each described above have preferably 1 to 10 carbon atoms and include, for example, methyl, ethyl, propyl, isopropyl, n-butyl, s-butyl, isobutyl, t-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, neopentyl, 1-methylpentyl, 2-methylpentyl, 1-pentylhexyl, 1-butylpentyl, 1-heptyloctyl, 3-methylpentyl, hydroxymethyl, 1-hydroxyethyl, 2-hydroxyethyl, 2-hydroxyisobutyl, 1,2-dihydroxyethyl, 1,3-dihydroxyisopropyl, 2,3-dihydroxy-t-butyl, 1,2,3-trihydroxypropyl, aminomethyl, 1-aminoethyl, 2-aminoethyl, 2-aminoisobutyl, 1,2-diaminoethyl, 1,3-diaminoisopropyl, 2,3-diamino-t-butyl, 1,2,3-triaminopropyl, cyanomethyl, 1-cyanoethyl, 2-cyanoethyl, 2-cyanoisobutyl, 1,2-dicyanoethyl, 1,3-dicyanoisopropyl, 2,3-dicyano-t-butyl, 1,2,3-tricyanopropyl, nitromethyl, 1-nitroethyl, 2-nitroethyl, 2-nitroisobutyl, 1,2-dinitroethyl, 2,3-dinitro-t-butyl g, 1,2,3-trinitropropyl, cyclopentyl, cyclohexyl, cyclooctyl, 3,5-tetramethylcyclohexyl and groups obtained by converting the above groups into divalent groups.

Among the above groups, preferred are methyl, ethyl, propyl, isopropyl, n-butyl, s-butyl, isobutyl, t-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, neopentyl, 1-methylpentyl, 1-pentylhexyl, 1-butylpentyl, 1-heptyloctyl, cyclohexyl, cyclooctyl, 3,5-tetramethylcyclohexyl and groups obtained by converting the above groups into divalent groups.

The alkenyl group and the alkenylene group each described above have preferably 2 to 16 carbon atoms and include, for example, vinyl, allyl, 1-butenyl, 2-butenyl, 3-butenyl, 1,3-butadienyl, 1-methylvinyl, styryl, 2,2-diphenylvinyl, 1,2-diphenylvinyl, 1-methylallyl, 1,1-dimethylallyl, 2-methylallyl, 1-phenylallyl, 2-phenylallyl, 3-phenylallyl, 3,3-diphenylallyl, 1,2-dimethylallyl, 1-phenyl-1-butenyl, 3-phenyl-1-butenyl and groups obtained by converting the above groups into divalent groups, and preferred are styryl, 2,2-diphenylvinyl, 1,2-diphenylvinyl group and groups obtained by converting the above groups into divalent groups.

The aralkyl group and the aralkylene group each described above have preferably 7 to 18 carbon atoms and include, for example, benzyl, 1-phenylethyl, 2-phenylethyl, 1-phenylisopropyl, 2-phenylisopropyl, phenyl-t-butyl, α-naphthylmethyl, 1-α-naphthylethyl, 2-α-naphthylethyl, 1-α-naphthylisopropyl, 2-α-naphthylisopropyl, β-naphthylmethyl, 1-β-naphthylethyl, 2-β-naphthylethyl, 1-β-naphthylisopropyl, 2-β-naphthylisopropyl, 1-pyrrolylmethyl, 2-(1-pyrrolyl)ethyl, p-methylbenzyl, m-methylbenzyl, o-methylbenzyl, p-chlorobenzyl, m-chlorobenzyl, o-chlorobenzyl, p-bromobenzyl, m-bromobenzyl, o-bromobenzyl, p-iodobenzyl, m-iodobenzyl, o-iodobenzyl, p-hydroxybenzyl, m-hydroxybenzyl, o-hydroxybenzyl, p-aminobenzyl, m-aminobenzyl, o-aminobenzyl, p-nitrobenzyl, m-nitrobenzyl, o-nitrobenzyl, p-cyanobenzyl, m-cyanobenzyl, o-cyanobenzyl, 1-hydroxy-2-phenylisopropyl, 1-chloro-2-phenylisopropyl and groups obtained by converting the above groups into divalent groups, and preferred are benzyl, p-cyanobenzyl, m-cyanobenzyl, o-cyanobenzyl, 1-phenylethyl, 2-phenylethyl, 1-phenylisopropyl, 2-phenylisopropyl and groups obtained by converting the above groups into divalent groups.

The amino group or the hydroxyl group-containing hydrocarbon group each described above includes amino groups having the respective hydrocarbon groups represented by L¹ described above and groups obtained by substituting hydrogen atoms of the hydrocarbon groups described above with hydroxyl groups.

In Formula (1), L² represents a ligand comprising a monovalent heterocycle having 3 to 30 nuclear carbon atoms which may have a substituent, carboxylic acid ester having 1 to 30 carbon atoms which may have a substituent, carboxylic amide having 1 to 30 carbon atoms, amine which may have a substituent, phosphine which may have a substituent, isonitrile which may have a substituent, ether having 1 to 30 carbon atoms which may have a substituent, thioether having 1 to 30 carbon atoms which may have a substituent or a double bond-containing compound having 1 to 30 carbon atoms which may have a substituent, and when L¹ is cross-linked with L², it is a monovalent group of each ligand described above.

The heterocycle described above includes groups obtained by converting groups in the same examples as given in L¹ described above into groups of zero valence.

The carboxylic acid ester described above includes, for example, methyl formate, ethyl formate, methyl acetate, ethyl acetate, methyl propionate, ethyl propionate, methyl benzoate, ethyl benzoate, methyl 2-pyridinecarboxylate, ethyl 2-pyridinecarboxylate, methyl 3-pyridinecarboxylate, ethyl 3-pyridinecarboxylate, methyl 4-pyridinecarboxylate, ethyl 4-pyridinecarboxylate, methyl phenylacetate, ethyl phenylacetate, methyl 2-pyridinacetate, ethyl 2-pyridinacetate, methyl 3-pyridinacetate, ethyl 3-pyridinacetate, methyl 4-pyridinacetate, ethyl 4-pyridinacetate, methyl 2-pyrrolecarboxylate, methyl 3-pyrrolecarboxylate, methyl 2-thiophenecarboxylate and methyl 3-thiophenecarboxylate.

The carboxylic amide described above includes, for example, N,N-dimethylformamide, N,N-dimethylacetamide, N,N-dimethylbenzoamide, N,N-dimethyl-2-pyridinecarboxylic amide, N,N-dimethyl-3-pyridinecarboxylic amide, N,N-dimethyl-4-pyridinecarboxylic amide, N,N-dimethyl-phenylacetamide, N,N-dimethyl-2-pyridineacetamide, N,N-dimethyl-3-pyridineacetamide, N,N-dimethyl-4-pyridineacetamide, N,N-dimethyl-2-pyrrolecarboxylic amide, N,N-dimethyl-3-pyrrolecarboxylic amide, N,N-dimethyl-2-thiophenecarboxylic amide, N,N-dimethyl-3-thiophenecarboxylic amide, N-methylformamide, N-methylacetamide, N-methylbenzoamide, N-methyl-2-pyridinecarboxylic amide, N-methyl-3-pyridinecarboxylic amide, N-methyl-4-pyridinecarboxylic amide, N-methyl-phenylacetamide, N-methyl-2-pyridineacetamide, N-methyl-3-pyridineacetamide, N-methyl-4-pyridineacetamide, N-methyl-2-pyrrolecarboxylic amide, N-methyl-3-pyrrolecarboxylic amide, N-methyl-2-thiophenecarboxylic amide, N-methyl-3-thiophenecarboxylic amide, acetamide, benzoamide, 2-pyridinecarboxylic amide, 3-pyridinecarboxylic amide, 4-pyridinecarboxylic amide, 2-pyridineacetamide, 3-pyridineacetamide, 4-pyridineacetamide, 2-pyrrolecarboxylic amide, 3-pyrrolecarboxylic amide, 2-thiophenecarboxylic amide and 3-thiophenecarboxylic amide.

The amine described above includes, for example, triethylamine, tri-n-propylamine, tri-n-butylamine, N,N-dimethylaniline, methyldiphenylamine, triphenylamine, dimethyl(2-pyridine)amine, dimethyl(3-pyridine)amine, dimethyl(4-pyridine)amine, methylbis(2-pyridine)amine, methylbis(3-pyridine)amine, methylbis(4-pyridine)amine, tris(2-pyridine)amine, tris(3-pyridine)amine, tris(4-pyridine)amine, diisopropylamine, di-n-propylamine, di-n-butylamine, N-methylaniline, methylphenylamine, diphenylamine, methyl(2-pyridine)amine, methyl(3-pyridine)amine, methyl(4-pyridine)amine, methyl(2-pyridine)amine, methyl(3-pyridine)amine, methyl(4-pyridine)amine, bis(2-pyridine)amine, n-propylamine, n-butylamine, aniline, (2-pyridine)amine, (3-pyridine)amine, (4-pyridine) amine, (2-pyridine) amine, (3-pyridine) amine, (4-pyridine)amine, pyridine, 2-methylpyridine, 3-methylpyridine, 4-methylpyridine, 2-trifluoromethylpyridine, 3-trifluoromethylpyridine, 4-trifluoromethylpyridine and N-methylpyrrole.

The phosphine described above includes, for example, phosphines obtained by substituting nitrogen of the amines described above with phosphorus.

The isonitrile described above includes, for example, butylisocyanide, isobutylisocyanide, sec-butylisocyanide, t-butylisocyanide, phenylisocyanide, 2-tolylisocyanide, 3-tolylisocyanide, 4-tolylisocyanide, 2-pyridineisocyanide, 3-pyridineisocyanide, 4-pyridineisocyanide and benzylisocyanide.

The ether described above includes, for example, diethyl ether, di-n-propyl ether, di-n-butyl ether, diisobutyl ether, di-sec-butyl ether, di-t-butyl ether, anisole, diphenyl ether, tetrahydrofuran and dioxane.

The thioether described above includes, for example, thioethers obtained by substituting oxygen of the ethers described above with sulfur.

The double bond-containing compound having 1 to 30 carbon atoms described above includes, for example, ethylene, propylene, 1-butene, 1-pentene, 1-hexene, 1-heptene, 1-octene, 1-nonene, 1-decene, 1-eicosene, 2-butene, 2-pentene, 2-hexene, 2-heptene, 2-octene, 2-nonene, 2-decene, 2-eicosene, 3-hexene, 3-heptene, 3-octene, 3-nonene, 3-decene, 3-eicosene, isobutene, styrene, α-methylstyrene, β-methylstyrene, butadiene, isoprene and stilbene.

In Formula (1), Z¹ is an atom forming a covalent bond with metal M, and it is a carbon, silicon, nitrogen or phosphorus atom; Z² is an atom forming a covalent bond with a substituent R¹, and it is a carbon, silicon, nitrogen or phosphorus atom; the A ring containing Z¹ and Z² and the B ring are an aromatic hydrocarbon group having 3 to 40 nuclear carbon atoms which may have a substituent or a heterocyclic group having 3 to 40 nuclear carbon atoms which may have a substituent.

The above aromatic hydrocarbon group includes the same examples as given above, and the examples of the above aromatic heterocyclic group include aromatic heterocyclic groups out of the examples of the heterocyclic group described above.

Among them, the A ring containing R¹, Z¹ and Z²:

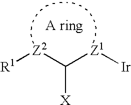

assumes preferably structures shown below. In the following examples, the example of M is shown by Ir, but the same examples shall be given as well in the case of M other than Ir. X represents a ring structure containing the adjacent B ring. A bond (→) of X with Ir is abbreviated.

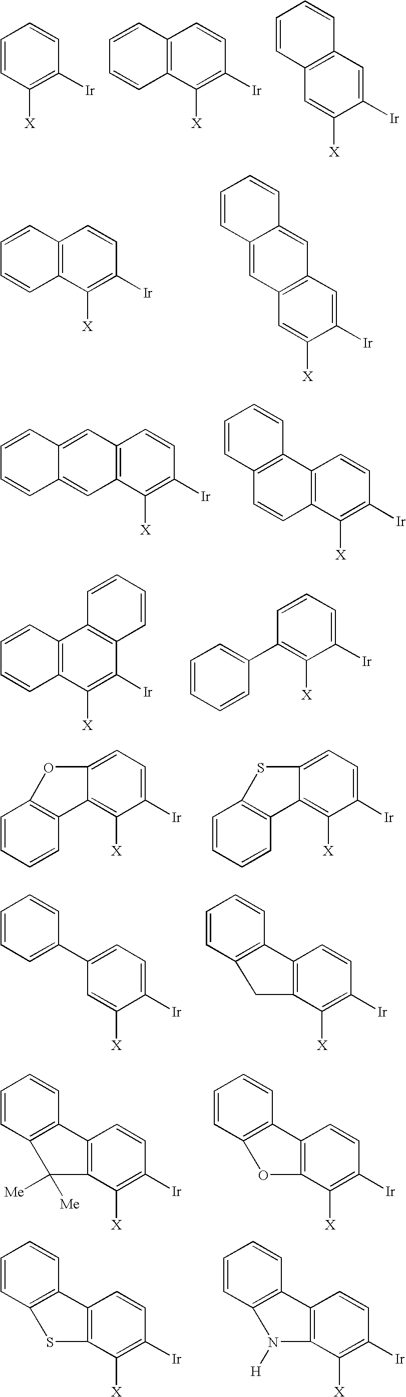

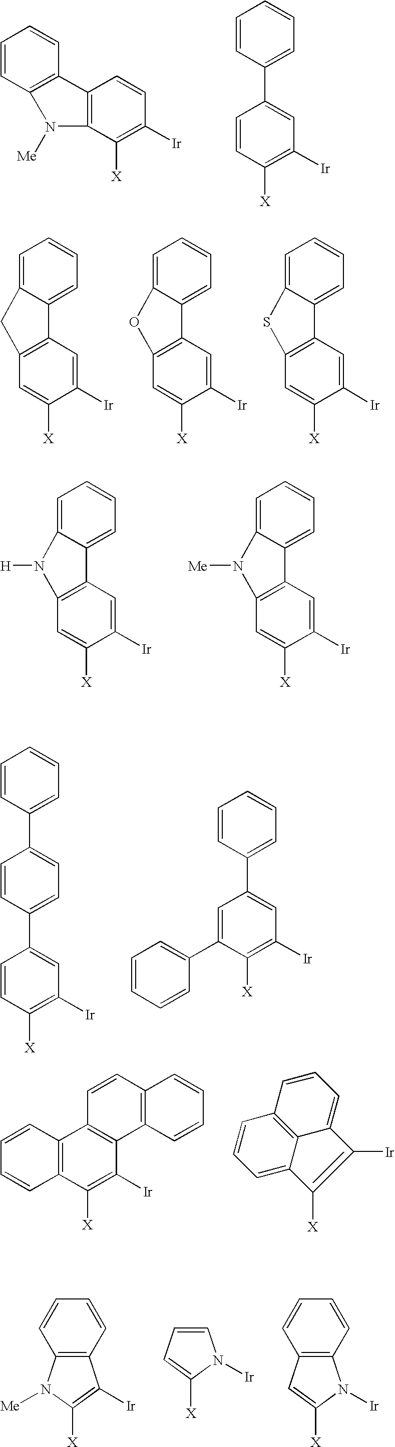

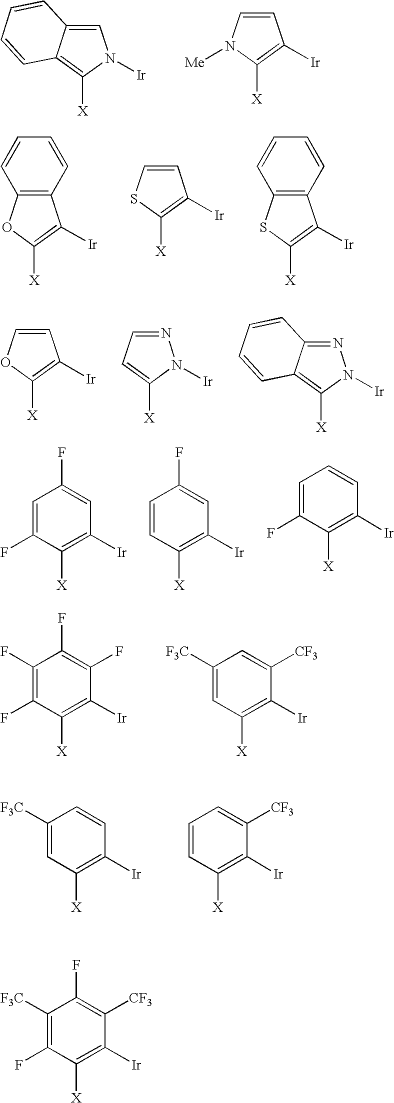

A structure containing Z³ and the B ring:

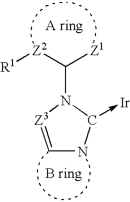

assumes preferably structures shown below. In the following examples, the example of M is shown by Ir, but the same examples shall be given as well in the case of M other than Ir. R¹ and the A ring structure containing Z¹ and Z² shall be described merely in the abbreviated form of the A ring. A bond (—) of the A ring with Ir is abbreviated.

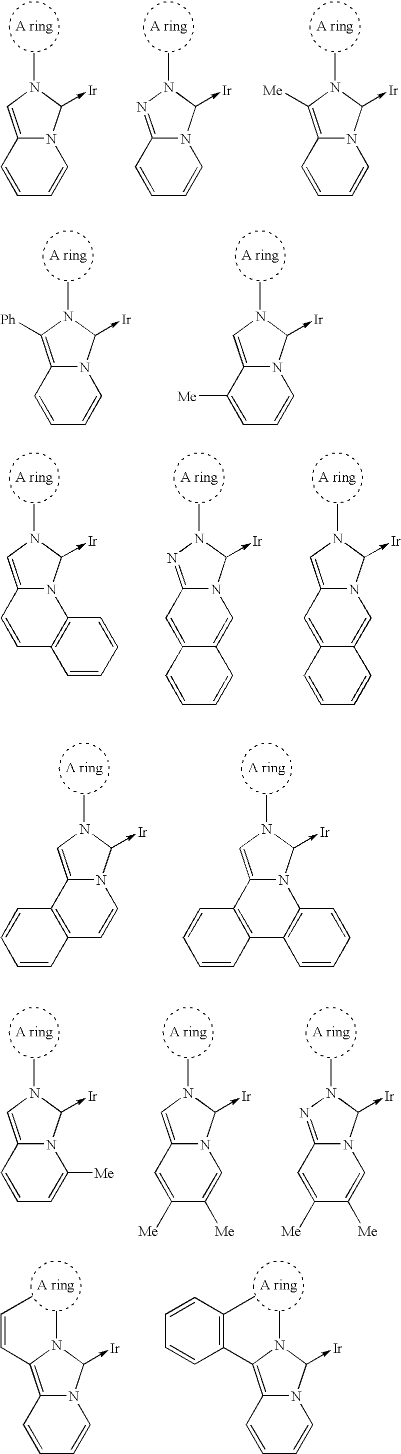

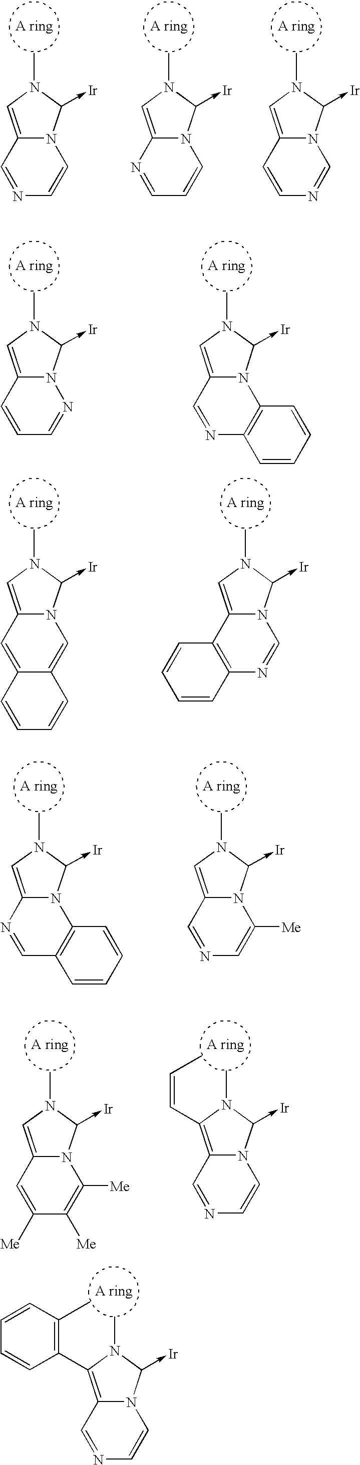

In Formula (1), Z³ represents a nitrogen atom or CR², and when CR² is plural, plural R² may be the same or different.

R¹ and R² described above each represent independently a hydrogen atom, a halogen atom, a thiocyano group, a cyano group, a nitro group, a —S(═O)₂R¹⁸ or a —S(═O)R¹⁸, an alkyl group having 1 to 30 carbon atoms which may have a substituent, a halogenated alkyl group having 1 to 30 carbon atoms which may have a substituent, an aromatic hydrocarbon group having 6 to 30 nuclear carbon atoms which may have a substituent, a cycloalkyl group having 3 to 30 nuclear carbon atoms which may have a substituent, an aralkyl group having 7 to 40 carbon atoms which may have a substituent, an alkenyl group having 2 to 30 carbon atoms which may have a substituent, a heterocyclic group having 3 to 30 nuclear carbon atoms which may have a substituent, an alkoxy group having 1 to 30 carbon atoms which may have a substituent, an aryloxy group having 6 to 30 nuclear carbon atoms which may have a substituent, an alkylamino group having 3 to 30 nuclear carbon atoms which may have a substituent, an arylamino group having 6 to 30 carbon atoms which may have a substituent, an alkylsilyl group having 3 to 30 nuclear carbon atoms which may have a substituent, an arylsilyl group having 6 to 30 carbon atoms which may have a substituent or a carboxyl-containing group having 1 to 30 carbon atoms, and when Z³ is CR², R¹ may be cross-linked with R².

(R¹⁸ described above each is independently a hydrogen atom, an alkyl group having 1 to 30 carbon atoms which may have a substituent, a halogenated alkyl group having 1 to 30 carbon atoms which may have a substituent, an aromatic hydrocarbon group having 6 to 30 nuclear carbon atoms which may have a substituent, a cycloalkyl group having 3 to 50 nuclear carbon atoms which may have a substituent, an aralkyl group having 7 to 40 carbon atoms which may have a substituent, an alkenyl group having 2 to 30 carbon atoms which may have a substituent, a heterocyclic group having 3 to 30 nuclear carbon atoms which may have a substituent, an alkoxy group having 1 to 30 carbon atoms which may have a substituent, an aryloxy group having 6 to 30 nuclear carbon atoms which may have a substituent, an alkylamino group having 3 to 30 carbon atoms which may have a substituent, an arylamino group having 6 to 30 carbon atoms which may have a substituent, an alkylsilyl group having 3 to 30 carbon atoms which may have a substituent, an arylsilyl group having 6 to 30 carbon atoms which may have a substituent or a carboxyl-containing group having 1 to 30 carbon atoms which may have a substituent).

The alkyl group described above has preferably 1 to 10 carbon atoms and includes, for example, methyl, ethyl, propyl, isopropyl, n-butyl, s-butyl, isobutyl, t-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, neopentyl, 1-methylpentyl, 2-methylpentyl, 1-pentylhexyl, 1-butylpentyl, 1-heptyloctyl, 3-methylpentyl, hydroxymethyl, 1-hydroxyethyl, 2-hydroxyethyl, 2-hydroxyisobutyl, 1,2-dihydroxyethyl, 1,3-dihydroxyisopropyl, 2,3-dihydroxy-t-butyl, 1,2,3-trihydroxypropyl, aminomethyl, 1-aminoethyl, 2-aminoethyl, 2-aminoisobutyl, 1,2-diaminoethyl, 1,3-diaminoisopropyl, 2,3-diamino-t-butyl, 1,2,3-triaminopropyl, cyanomethyl, 1-cyanoethyl, 2-cyanoethyl, 2-cyanoisobutyl, 1,2-dicyanoethyl, 1,3-dicyanoisopropyl, 2,3-dicyano-t-butyl, 1,2,3-tricyanopropyl, nitromethyl, 1-nitroethyl, 2-nitroethyl, 2-nitroisobutyl, 1,2-dinitroethyl, 2,3-dinitro-t-butyl, 1,2,3-trinitropropyl, cyclopentyl, cyclohexyl, cyclooctyl and 3,5-tetramethylcyclohexyl.

Among the above groups, preferred are methyl, ethyl, propyl, isopropyl, n-butyl, s-butyl, isobutyl, t-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, neopentyl, 1-methylpentyl, 1-pentylhexyl, 1-butylpentyl, 1-heptyloctyl, cyclohexyl, cyclooctyl and 3,5-tetramethylcyclohexyl.

The halogenated alkyl group described above has preferably 1 to 10 carbon atoms and includes, for example, chloromethyl, 1-chloroethyl, 2-chloroethyl, 2-chloroisobutyl, 1,2-dichloroethyl, 1,3-dichloroisopropyl, 2,3-dichloro-t-butyl, 1,2,3-trichloropropyl, bromomethyl, 1-bromoethyl, 2-bromoethyl, 2-bromoisobutyl, 1,2-dibromoethyl, 1,3-dibromoisopropyl, 2,3-dibromo-t-butyl, 1,2,3-tribromopropyl, iodomethyl, 1-iodoethyl group, 2-iodoethyl, 2-iodoisobutyl, 1,2-diiodoethyl, 1,3-diiodoisopropyl, 2,3-diiodo-t-butyl, 1,2,3-triiodopropyl, fluoromethyl, 1-fluoromethyl, 2-fluoromethyl, 2-fluoroisobutyl, 1,2-difluoroethyl, difluoromethyl, trifluoromethyl, pentafluoroethyl, perfluoroisopropyl, perfluorobutyl and perfluorocyclohexyl.

Among the above groups, preferred are fluoromethyl group, trifluoromethyl, pentafluoroethyl, perfluoroisopropyl, perfluorobutyl and perfluorocyclohexyl.

The aromatic hydrocarbon group described above has preferably 6 to 18 nuclear carbon atoms and includes, for example, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, 1-naphthacenyl, 2-naphthacenyl, 9-naphthacenyl, 1-pyrenyl, 2-pyrenyl, 4-pyrenyl, 2-biphenylyl, 3-biphenylyl, 4-biphenylyl, p-terphenyl-4-yl, p-terphenyl-3-yl, p-terphenyl-2-yl, m-terphenyl-4-yl, m-terphenyl-3-yl, m-terphenyl-2-yl, o-tolyl, m-tolyl, p-tolyl, p-t-butylphenyl, p-(2-phenylpropyl)phenyl, 3-methyl-2-naphthyl, 4-methyl-1-naphthyl, 4-methyl-1-anthryl, 4′-methylbiphenylyl, 4″-t-butyl-p-terphenyl-4-yl, o-cumenyl, m-cumenyl, p-cumenyl, 2,3-xylylenyl, 3,4-xylylenyl, 2,5-xylylenyl, mesitylenyl and perfluorophenyl.

Among them, preferred are phenyl, 1-naphthyl, 2-naphthyl, 9-phenanthryl, 2-biphenylyl, 3-biphenylyl, 4-biphenylyl, p-tolyl and 3,4-xylyl.

The cycloalkyl group described above includes, for example, cyclopropyl, cyclobutyl, cyclopentyl, cyclohexyl, 4-methylcyclohexyl, 1-adamantyl, 2-adamantyl, 1-norbornyl and 2-norbornyl.

The aralkyl group described above has preferably 7 to 18 carbon atoms and includes, for example, benzyl, 1-phenylethyl, 2-phenylethyl, 1-phenylisopropyl, 2-phenylisopropyl, phenyl-t-butyl, α-naphthylmethyl, 1-α-naphthylethyl, 2-α-naphthylethyl, 1-α-naphthylisopropyl, 2-α-naphthylisopropyl, β-naphthylmethyl, 1-β-naphthylethyl, 2-β-naphthylethyl, 1-β-naphthylisopropyl, 2-β-naphthylisopropyl, 1-pyrrolylmethyl, 2-(1-pyrrolyl)ethyl, p-methylbenzyl, m-methylbenzyl, o-methylbenzyl, p-chlorobenzyl, m-chlorobenzyl, o-chlorobenzyl, p-bromobenzyl, m-bromobenzyl, o-bromobenzyl, p-iodobenzyl, m-iodobenzyl, o-iodobenzyl, p-hydroxybenzyl, m-hydroxybenzyl, o-hydroxybenzyl, p-aminobenzyl, m-aminobenzyl, o-aminobenzyl, p-nitrobenzyl, m-nitrobenzyl, o-nitrobenzyl, p-cyanobenzyl, m-cyanobenzyl, o-cyanobenzyl, 1-hydroxy-2-phenylisopropyl and 1-chloro-2-phenylisopropyl, and preferred are benzyl, p-cyanobenzyl, m-cyanobenzyl, o-cyanobenzyl, 1-phenylethyl, 2-phenylethyl, 1-phenylisopropyl and 2-phenylisopropyl.

The alkenyl group described above has preferably 2 to 16 carbon atoms and includes, for example, vinyl, allyl, 1-butenyl, 2-butenyl, 3-butenyl, 1,3-butadienyl, 1-methylvinyl, styryl, 2,2-diphenylvinyl, 1,2-diphenylvinyl, 1-methylallyl, 1,1-dimethylallyl, 2-methylallyl, 1-phenylallyl, 2-phenylallyl, 3-phenylallyl, 3,3-diphenylallyl, 1,2-dimethylallyl, 1-phenyl-1-butenyl and 3-phenyl-1-butenyl, and styryl, 2,2-diphenylvinyl and 1,2-diphenylvinyl are preferred.

The heterocyclic group described above has preferably 3 to 18 nuclear carbon atoms and includes, for example, 1-pyrrolyl, 2-pyrrolyl, 3-pyrrolyl, pyrazinyl, 2-pyridinyl, 1-imidazolyl, 2-imidazolyl, 1-pyrazolyl, 1-indolidinyl, 2-indolidinyl, 3-indolidinyl, 5-indolidinyl, 6-indolidinyl, 7-indolidinyl, 8-indolidinyl, 2-imidazopyridinyl, 3-imidazopyridinyl, 5-imidazopyridinyl, 6-imidazopyridinyl, 7-imidazopyridinyl, 8-imidazopyridinyl, 3-pyridinyl, 4-pyridinyl, 1-indolyl, 2-indolyl, 3-indolyl, 4-indolyl, 5-indolyl, 6-indolyl, 7-indolyl, 1-isoindolyl, 2-isoindolyl, 3-isoindolyl, 4-isoindolyl, 5-isoindolyl, 6-isoindolyl, 7-isoindolyl, 2-furyl, 3-furyl, 2-benzofuranyl, 3-benzofuranyl, 4-benzofuranyl, 5-benzofuranyl, 6-benzofuranyl, 7-benzofuranyl, 1-isobenzofuranyl, 3-isobenzofuranyl, 4-isobenzofuranyl, 5-isobenzofuranyl, 6-isobenzofuranyl, 7-isobenzofuranyl, 2-quinolyl, 3-quinolyl, 4-quinolyl, 5-quinolyl, 6-quinolyl, 7-quinolyl, 8-quinolyl, 1-isoquinolyl, 3-isoquinolyl, 4-isoquinolyl, 5-isoquinolyl, 6-isoquinolyl, 7-isoquinolyl, 8-isoquinolyl, 2-quinoxalinyl, 5-quinoxalinyl, 6-quinoxalinyl, 1-carbazolyl, 2-carbazolyl, 3-carbazolyl, 4-carbazolyl, 9-carbazolyl, β-carboline-1-yl, β-carboline-3-yl, β-carboline-4-yl, β-carboline-5-yl, β-carboline-6-yl, β-carboline-7-yl, β-carboline-6-yl, β-carboline-9-yl, 1-phenanthridinyl, 2-phenanthridinyl, 3-phenanthridinyl, 4-phenanthridinyl, 6-phenanthridinyl, 7-phenanthridinyl, 8-phenanthridinyl, 9-phenanthridinyl, 10-phenanthridinyl, 1-acridinyl, 2-acridinyl, 3-acridinyl, 4-acridinyl, 9-acridinyl, 1,7-phenanthroline-2-yl, 1,7-phenanthroline-3-yl, 1,7-phenanthroline-4-yl, 1,7-phenanthroline-5-yl, 1,7-phenanthroline-6-yl, 1,7-phenanthroline-8-yl, 1,7-phenanthroline-9-yl, 1,7-phenanthroline-10-yl, 1,8-phenanthroline-2-yl, 1,8-phenanthroline-3-yl, 1,8-phenanthroline-4-yl, 1,8-phenanthroline-5-yl, 1,8-phenanthroline-6-yl, 1,8-phenanthroline-7-yl, 1,8-phenanthroline-9-yl, 1,8-phenanthroline-10-yl, 1,9-phenanthroline-2-yl, 1,9-phenanthroline-3-yl, 1,9-phenanthroline-4-yl, 1,9-phenanthroline-5-yl, 1,9-phenanthroline-6-yl, 1,9-phenanthroline-7-yl, 1,9-phenanthroline-8-yl, 1,9-phenanthroline-10-yl, 1,10-phenanthroline-2-yl, 1,10-phenanthroline-3-yl, 1,10-phenanthroline-4-yl, 1,10-phenanthroline-5-yl 2,9-phenanthroline-1-yl, 2,9-phenanthroline-3-yl, 2,9-phenanthroline-4-yl, 2,9-phenanthroline-5-yl, 2,9-phenanthroline-6-yl, 2,9-phenanthroline-7-yl, 2,9-phenanthroline-8-yl, 2,9-phenanthroline-10-yl, 2,8-phenanthroline-1-yl, 2,8-phenanthroline-3-yl, 2,8-phenanthroline-4-yl, 2,8-phenanthroline-5-yl, 2,8-phenanthroline-6-yl, 2,8-phenanthroline-7-yl, 2,8-phenanthroline-9-yl, 2,8-phenanthroline-10-yl, 2,7-phenanthroline-1-yl, 2,7-phenanthroline-3-yl, 2,7-phenanthroline-4-yl, 2,7-phenanthroline-5-yl, 2,7-phenanthroline-6-yl, 2,7-phenanthroline-8-yl, 2,7-phenanthroline-9-yl, 2,7-phenanthroline-10-yl, 1-phenazinyl, 2-phenazinyl, 1-phenothiazinyl, 2-phenothiazinyl, 3-phenothiazinyl, 4-phenothiazinyl, 10-phenothiazinyl, 1-phenoxazinyl, 2-phenoxazinyl, 3-phenoxazinyl, 4-phenoxazinyl, 10-phenoxazinyl, 2-oxazolyl, 4-oxazolyl, 5-oxazolyl, 2-oxadiazolyl, 5-oxadiazolyl, 3-furazanyl, 2-thienyl, 3-thienyl, 2-methylpyrrole-1-yl, 2-methylpyrrole-3-yl, 2-methylpyrrole-4-yl, 2-methyl-pyrrole-5-yl, 3-methylpyrrole-1-yl, 3-methylpyrrole-2-yl, 3-methylpyrrole-4-yl, 3-methylpyrrole-5-yl, 2-t-butylpyrrole-4-yl, 3-(2-phenylpropyl)pyrrole-1-yl, 2-methyl-1-indolyl, 4-methyl-1-indolyl, 2-methyl-3-indolyl, 4-methyl-3-indolyl, 2-t-butyl-1-indolyl, 4-t-butyl-1-indolyl, 2-t-butyl-3-indolyl, 4-t-butyl-3-indolyl, pyrrolidine, pyrazolidine and piperazine.

Among them, preferred are 2-pyridinyl, 1-indolidinyl, 2-indolidinyl, 3-indolidinyl, 5-indolidinyl, 6-indolidinyl, 7-indolidinyl, 8-indolidinyl, 2-imidazopyridinyl, 3-imidazopyridinyl, 5-imidazopyridinyl, 6-imidazopyridinyl, 7-imidazopyridinyl, 8-imidazopyridinyl, 3-pyridinyl, 4-pyridinyl, 1-indolyl, 2-indolyl, 3-indolyl, 4-indolyl, 5-indolyl, 6-indolyl, 7-indolyl, 1-isoindolyl, 2-isoindolyl, 3-isoindolyl, 4-isoindolyl, 5-isoindolyl, 6-isoindolyl, 7-isoindolyl, 1-carbazolyl, 2-carbazolyl, 3-carbazolyl, 4-carbazolyl and 9-carbazolyl.

The alkoxy group and the aryloxy group each described above are groups represented by —OX¹, and the examples of X¹ include the same groups as explained in the alkyl group, the halogenated alkyl group and the aryl group each described above.

The alkylamino group and the arylamino group each described above are groups represented by —NX¹X², and the examples of X¹ and X² each include the same groups as explained in the alkyl group, the halogenated alkyl group and the aryl group each described above.

The carboxyl-containing group described above includes, for example, methyl ester, ethyl ester and butyl ester.

The alkylsilyl group described above includes, for example, trimethylsilyl, triethylsilyl, t-butyldimethylsilyl, vinyldimethylsilyl and propyldimethylsilyl.

The arylsilyl group described above includes, for example, triphenylsilyl, phenyldimethylsilyl and t-butyldiphenylsilyl.

The examples of the ring structure formed by cross-linking R¹ with R² include the same ones as given in the heterocyclic group described above.

In Formula (1), when k is plural, Z¹, Z², Z³, R¹, the A ring and the B ring may be the same as or different from each other and may be cross-linked with adjacent ones.

The compound represented by Formula (1) described above is preferably a transition metal complex compound having a metal carbene bond represented by the following Formula (2):

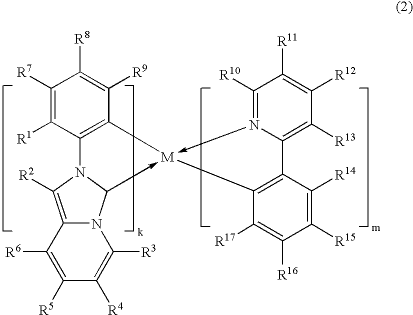

In Formula (2), C (carbon atom)→M represents a metal carbene bond; R¹, R², M and k each are the same as described above; m is an integer of 0 to 2, and k+m represents a valence of metal M.

In Formula (2), R³ to R¹⁷ each represent independently a hydrogen atom, a halogen atom, a thiocyano group, a cyano group, a nitro group, a —S(═O)₂R¹⁸, a —S(═P)R¹⁸ (R¹⁸ is the same as described above), an alkyl group having 1 to 30 carbon atoms which may have a substituent, a halogenated alkyl group having 1 to 30 carbon atoms which may have a substituent, an aromatic hydrocarbon group having 6 to 30 nuclear carbon atoms which may have a substituent, a cycloalkyl group having 3 to 30 nuclear carbon atoms which may have a substituent, an aralkyl group having 7 to 40 carbon atoms which may have a substituent, an alkenyl group having 2 to 30 carbon atoms which may have a substituent, a heterocyclic group having 3 to 30 nuclear carbon atoms which may have a substituent, an alkoxy group having 1 to 30 carbon atoms which may have a substituent, an aryloxy group having 6 to 30 nuclear carbon atoms which may have a substituent, an alkylamino group having 3 to 30 nuclear carbon atoms which may have a substituent, an arylamino group having 6 to 30 carbon atoms which may have a substituent, an alkylsilyl group having 3 to 30 nuclear carbon atoms which may have a substituent, an arylsilyl group having 6 to 30 carbon atoms which may have a substituent or a carboxyl-containing group having 1 to 30 carbon atoms, and R³ to R¹⁷ may be cross-linked with adjacent ones.

The specific examples of the above respective groups include the same examples as those of R¹ and R² in Formula (1). Also, M described above is preferably Ir.

Next, Formula (3) shall be explained:

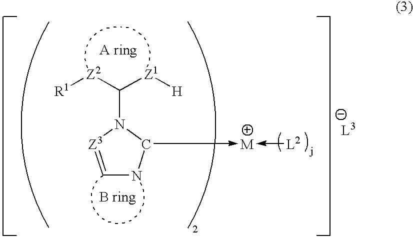

In Formula (3), C (carbon atom)→M represents a metal carbene bond, and a bond shown by an arrow represents a coordinate bond. M is the same as described above and is preferably Ir.

In Formula (3), L² represents a unidentate ligand; j is the same as described above; and when j is plural, respective L² may be the same as or different from each other and may be cross-linked.

In Formula (3), L² is the same ligand as described above and includes the same examples.

In Formula (3), L³ represents a conjugated base of superstrong acids having a pKa value of −10 or less, carboxylic acids, aldehydes, ketones, alcohols, thioalcohols, phenols, amines, amides, aromatics or alkanes, a hydrogen ion or a halide ion, and superstrong acids having a pKa value of −10 or less and a halide ion are preferred.

The conjugated bases of the superstrong acids having a pKa value of −10 or less described above include SbF₆⁻, FSO₃⁻, ClO₄⁻, I⁻, TfO⁻, Tf₂N⁻ (Tf=CF₃SO₂⁻) and the like; the conjugated bases of the carboxylic acids include RCOO⁻, ArCOO⁻ and the like; the conjugated bases of the aldehydes include R—COH and the like; the conjugated bases of the ketones include R—COR′ and the like; the conjugated bases of the alcohols include RO⁻ and the like; the conjugated bases of the thioalcohols include RSO⁻ and the like; the conjugated bases of the phenols include ArO⁻ and the like; the conjugated bases of the amines include RR′N⁻ and the like; the conjugated bases of the amides include RR′NCOR″⁻ and the like; the conjugated bases of the aromatics include (substituted) cyclopentadienyl anion, Ar⁻ and the like; the conjugated bases of the alkanes include Me⁻, t-Bu⁻ (Me is methane, and Bu is butane) and the like; and the conjugated bases of the halide ions include F⁻, Cl⁻, Br⁻ and I⁻.

The examples of R, R′ and R″ include the same examples as those of R¹⁸ described above.

In Formula (3), the specific examples of L³-L² (ligand in which L³ is cross-linked with L²) include, for example, conjugated bases of (substituted) acetylacetones, conjugated bases of β-ketoimines, conjugated bases of β-diimines, conjugated bases of (substituted) picolinic acid, conjugated bases of (substituted) malonic acid diesters, conjugated bases of (substituted) acetoacetic acid esters, conjugated bases of (substituted) acetoacetic amides and conjugated bases of (substituted) amidinates.

In Formula (3), Z¹ is a carbon, silicon, nitrogen or phosphorus atom, and Z², Z³ and R¹ each are the same as described above and include the same examples.

In Formula (3), the specific examples of the A ring containing R¹, Z¹ and Z² and the B ring containing Z³ include the same examples as in Formula (1) described above.

Z¹, Z², Z³, R¹, the A ring and the B ring which are two respectively may be the same as or different from each other and may be cross-linked with adjacent ones.

Next, Formula (4) shall be explained:

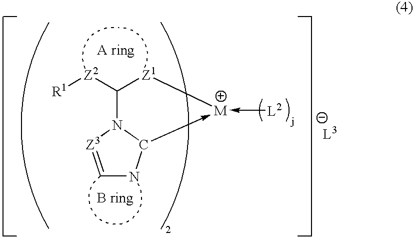

In Formula (4), C (carbon atom)→M represents a metal carbene bond; a bond shown by a solid line (—) represents a covalent bond; a bond shown by an arrow (→) represents a coordinate bond; M is the same as described above; L² represents a unidentate ligand; j is the same as described above; when j is plural, respective L² may be the same as or different from each other and may be cross-linked.

L² is the same ligand as described above, and L³, Z¹, Z², Z³ and R¹ each are the same as described above and include the same examples.

In Formula (4), the specific examples of the A ring containing R¹, Z¹ and Z² and the B ring containing Z³ includes the same examples as in Formula (1) described above.

The specific examples of L³-L² (ligand in which L³ is cross-linked with L²) include as well the same examples.

Z¹, Z², Z³, R¹, the A ring and the B ring which are two respectively may be the same as or different from each other and may be cross-linked with adjacent ones.

In the production process of the present invention for a transition metal compound having a metal carbene bond represented by Formula (7), an iridium compound represented by the following Formula (5) is reacted with an imidazolium salt represented by the following Formula (6) in the presence of a solvent and a base to produce the transition metal compound represented by Formula (7):

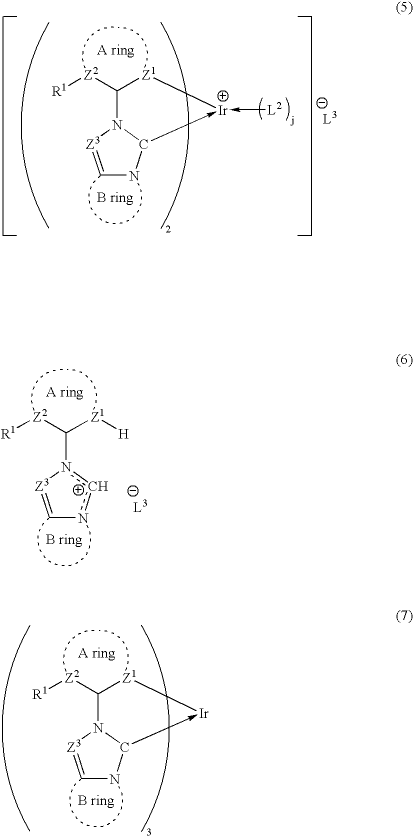

In Formulas (5) to (7), C (carbon atom)→Ir (iridium) represents a metal carbene bond; a bond shown by a solid line (—) represents a covalent bond; a bond shown by an arrow (→) represents a coordinate bond; L² represents a unidentate ligand; j is the same as described above; when j is plural, respective L² may be the same as or different from each other and may be cross-linked.

L² is the same ligand as described above, and L³, Z¹, Z², Z³ and R¹ each are the same as described above and include the same examples.

In Formula (4), the specific examples of an A ring containing R¹, Z¹ and Z² and a B ring containing Z³ include the same examples as in Formula (1) described above.

Z¹, Z²_{, Z}³, R¹, the A ring and the B ring which are two respectively may be the same as or different from each other and may be cross-linked with adjacent ones.

In the above production process, the solvent described above includes (substituted) aromatic hydrocarbons, (substituted) hetero atom-containing aromatics, (substituted) linear ethers, (substituted) cyclic ethers, (substituted) cyclic thioethers, (substituted) alcohols and (substituted) aliphatic hydrocarbons. To be specific, the (substituted) aromatic hydrocarbons include benzene, toluene, xylene, mesitylene and 1,2,3,4-tetrahydronaphthalene. The (substituted) hetero atom-containing aromatics include pyridine derivatives such as pyridine, 2-methylpyridine, 3-methylpyridine, 4-methylpyridine, 2,6-dimethylpyridine, quinoline and isoquinoline, furan derivatives such as furan, 2-methylfuran, 3-methylfuran, 2,5-dimethylfuran and benzofuran and thiophene derivatives such as thiophene, 2-methylthiophene, 3-methylthiophene, 2,5-dimethylthiophene and benzothiophene. The (substituted) linear ethers include diisopropyl ether, di-n-butyl ether and diethylene glycol diethyl ether. The (substituted) cyclic ethers include tetrahydrofuran derivatives such as tetrahydrofuran, 2-methyltetrahydrofuran, 3-methyltetrahydrofuran, 2,5-dimethyltetrahydrofuran and 2,2,5,5-tetramethyltetrahydrofuran. The (substituted) cyclic thioethers include tetrahydrothiophene derivatives such as tetrahydrothiophene, 2-methyltetrahydrothiophene, 3-methyltetrahydrothiophene, 2,5-dimethyltetrahydrothiophene and 2,2,5,5-tetramethyltetrahydrothiophene. The (substituted) alcohols include 2-methoxyethanol, diethylene glycol, tetrahydrofurfuryl alcohol, 1,4-butanediol, 1,6-hexanediol and glycerol. The (substituted) aliphatic hydrocarbons include n-decane, n-dodecane, n-undecane and decalin. Among them, the (substituted) cyclic ethers, the (substituted) alcohols and the (substituted) aromatic hydrocarbons are preferred, and (substituted) tetrahydrofurans which are the (substituted) cyclic ethers are more preferred.

The base described above includes compounds comprising combination of conjugate bases of acids having an acid dissociation constant (pKa value) of 8 or more, preferably 15 or more and more preferably 15 or more and 40 or less and metals and metal oxides which are basic oxides. The conjugate bases of acids having an acid dissociation constant (pKa value) of 15 or more and 40 or less include alkoxide anions, acid amide anions, amides, alkylamide anions and arylamide anions. The specific examples of the alkoxide anions include methoxide anion and ethoxide anion. The specific examples of the acid amide anions include benzoic amide anion and acetamide anions. The alkylamide anions include methylamide anion and ethylamide anion. The arylamide anions include anilide anion. The metals combined with the above conjugate bases include lithium cation, sodium cation, potassium cation and magnesium cation. The metal oxides which are basic oxides include magnesium oxide, lithium oxide, sodium oxide, calcium oxide, copper oxide and silver oxide, and silver oxide is preferred.

Substituents for the respective groups in Formulas (1) to (7) described above include a substituted or non-substituted aryl group having 5 to 50 nuclear carbon atoms, a substituted or non-substituted alkyl group having 1 to 50 carbon atoms, a substituted or non-substituted alkoxy group having 1 to 50 carbon atoms, a substituted or non-substituted aralkyl group having 6 to 50 nuclear carbon atoms, a substituted or non-substituted aryloxy group having 5 to 50 nuclear carbon atoms, a substituted or non-substituted arylthio group having 5 to 50 nuclear carbon atoms, a substituted or non-substituted alkoxycarbonyl group having 1 to 50 carbon atoms, an amino group, a halogen atom, a cyano group, a nitro group, a hydroxyl group and a carboxyl group.

Among them, an alkyl group having 1 to 10 carbon atoms, a cycloalkyl, group having 5 to 7 carbon atoms and an alkoxy group having 1 to 10 carbon atoms are preferred, and an alkyl group having 1 to 6 carbon atoms and a cycloalkyl group having 5 to 7 carbon atoms are more preferred. Particularly preferred are methyl, ethyl, n-propyl, isopropyl, n-butyl, sec-butyl, tert-butyl, n-pentyl, n-hexyl, cyclopentyl and cyclohexyl.

The specific example of the transition metal complex compound of the present invention includes preferably examples in which a part containing an A ring and a part containing a B ring in the following Formula (8) are the same as described above respectively, but it shall not be restricted to them:

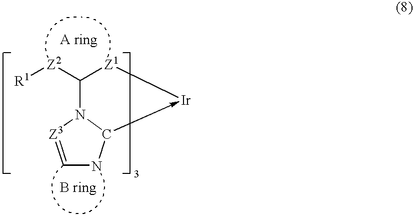

Next, the representative examples of the production process for the transition metal complex compound of the present invention shall be shown in the following synthetic routes, wherein in the case of Formula (2) described above, produced are (i) a compound in which M is an iridium atom and in which k is 3 and m is 0 and (ii) a compound in which M is an iridium atom and in which k is 1 and m is 2.

In the following synthetic routes, a ligand is synthesized according to a reference document (J. Am. Chem. Soc., 127 (10), 3290 to 3291, 2005), and X shown below represents an elimination group such as a halogen atom. Synthetic route:

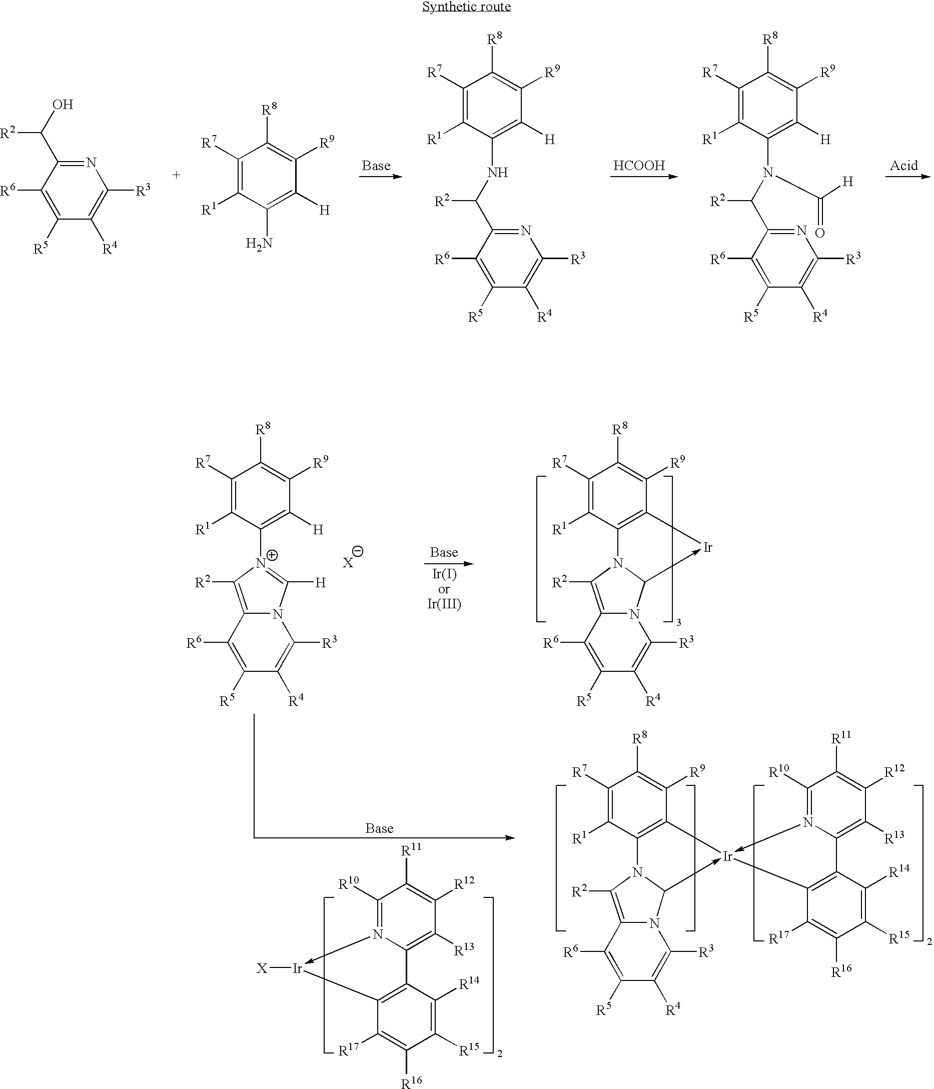

The specific example of the transition metal compound in Formula (1) shall be shown in the following synthetic route, wherein acac is acetylacetonate.

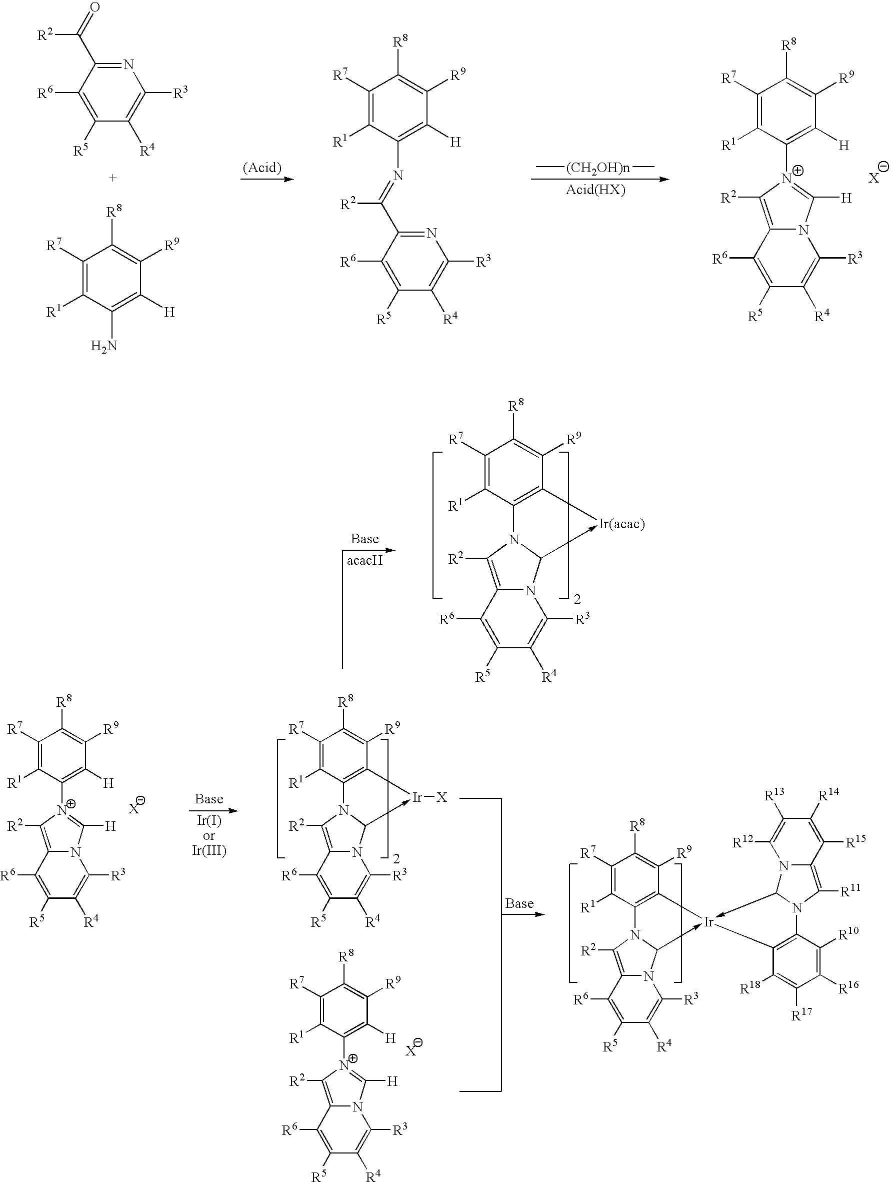

The organic EL device of the present invention is an organic EL device in which an organic thin film layer comprising a single layer or plural layers having at least a luminescent layer is interposed between a pair of electrodes comprising an anode and a cathode, wherein at least one layer in the organic thin film layer contains the transition metal complex compound of the present invention represented by one of Formulas (1), (3) and (4) and contains the transition metal complex compound represented by Formulas (3) and/or (4).

A content of the transition metal complex compound of the present invention contained in the organic thin film layer described above is usually 0.1 to 100% by weight, preferably 1 to 30% by weight based on the mass of the whole luminescent layer.

The organic EL device of the present invention preferably contains the transition metal complex compound of the present invention as a luminescent material or a dopant in the luminescent layer described above. Usually, the luminescent layer described above is reduced in a thickness by vacuum deposition or coating, and the layer containing the transition metal complex compound of the present invention is formed preferably by coating since coating makes it possible to simplify the production process.

In the organic EL device of the present invention, when the organic thin film layer is a single layer type, the organic thin film layer is a luminescent layer, and this luminescent layer contains the transition metal complex compound of the present invention. The organic EL device of a multilayer type includes devices comprising (anode/hole injecting layer (hole transporting layer)/luminescent layer/cathode), (anode/luminescent layer/electron injecting layer (electron transporting layer)/cathode) and (anode/hole injecting layer (hole transporting layer)/luminescent layer/electron injecting layer (electron transporting layer)/cathode).

The anode in the organic EL device of the present invention supplies holes to the hole injecting layer, the hole transporting layer and the luminescent layer, and it is effective that the anode has a work function of 4.5 eV or more. Metals, alloys, metal oxides, electrically conductive compounds and mixtures thereof can be used as a material for the anode. The specific examples of the material for the anode include electrically conductive metal oxides such as tin oxide, zinc oxide, indium oxide and indium tin oxide (ITO), metals such as gold, silver, chromium and nickel, mixtures or laminates of the above electrically conductive metal oxides and metals, inorganic conductive substances such as copper iodide and copper sulfide, organic conductive substances such as polyaniline, polythiophene and polypyrrole and laminates of the above substances with ITO. They are preferably the conductive metal oxides, and ITO is particularly preferably used from the viewpoint of a productivity, a high conductivity and a transparency. A thickness of the anode can suitably be selected according to the material.

The cathode in the organic EL device of the present invention supplies electrons to the electron injecting layer, the electron transporting layer and the luminescent layer. Metals, alloys, metal halides, metal oxides, electrically conductive compounds and mixtures thereof can be used as a material for the cathode. The specific examples of the material for the cathode include alkali metals (for example, Li, Na, K and the like) and fluorides and oxides thereof, alkaline earth metals (for example, Mg, Ca and the like) and fluorides and oxides thereof, gold, silver, lead, aluminum, sodium-potassium alloys or sodium-potassium mixed metals, lithium-aluminum alloys or lithium-aluminum mixed metals, magnesium-silver alloys or magnesium-silver mixed metals and rare earth metals such as indium, ytterbium and the like. Among them, aluminum, lithium-aluminum alloys or lithium-aluminum mixed metals and magnesium-silver alloys or magnesium-silver mixed metals are preferred. The cathode may have a single layer structure comprising the material described above or a laminate structure having a layer comprising the material described above. For example, laminate structures of aluminum/lithium fluoride and aluminum/lithium oxide are preferred. A thickness of the cathode can suitably be selected according to the material.

The hole injecting layer and the hole transporting layer in the organic EL device of the present invention may be ones having any of a function of injecting holes from the anode, a function of transporting holes and a function of cutting off electrons injected from the cathode. The specific examples thereof include carbazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine derivatives, styrylamine compounds, aromatic dimethylidene base compounds, porphyrin base compounds, polysilane base compounds, poly(N-vinylcarbazole) derivatives, aniline base copolymers, conductive high molecular oligomers such as thiophene oligomers and polythiophenes, organic silane derivatives and the transition metal complex compounds of the present invention. The hole injecting layer and the hole transporting layer each described above may have a single layer structure comprising at least one of the materials described above or a multilayer structure comprising plural layers having the same composition or different kinds of compositions.

The electron injecting layer and the electron transporting layer in the organic EL device of the present invention may be ones having any of a function of injecting electrons from the cathode, a function of transporting electrons and a function of cutting off holes injected from the anode. The specific examples thereof include triazole derivatives, oxazole derivatives, oxadiazole derivatives, imidazole derivatives, fluorenone derivatives, anthraquinodimethane derivatives, anthrone derivatives, diphenylquinone derivatives, thiopyran dioxide derivatives, carbodiimide derivatives, fluorenylidenemethane derivatives, distyrylpyrazine derivatives, tetracarboxylic anhydrides having an aromatic ring such as naphthalene and perylene, phthalocyanine derivatives, various metal complexes represented by metal complexes of 8-quinolinol derivatives and metal complexes comprising metal phthalocyanine, benzoxazole and benzothiazole as ligands, organic silane derivatives and the transition metal complex compounds of the present invention. The electron injecting layer and the electron transporting layer each described above may have a single layer structure comprising at least one of the materials described above or a multilayer structure comprising plural layers having the same composition or different kinds of compositions.

Further, electron transporting materials used for the electron injecting layer and the electron transporting layer include compounds shown below.

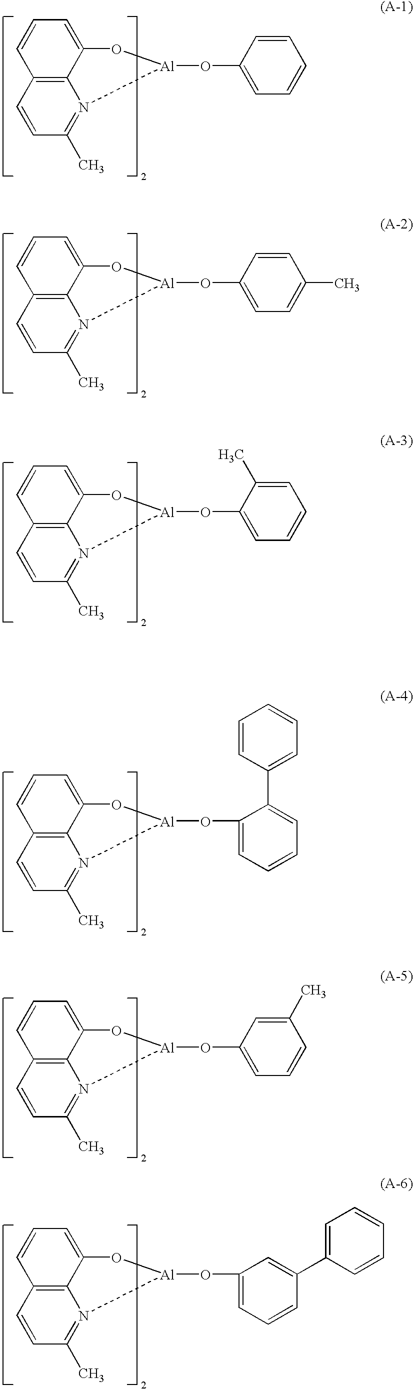

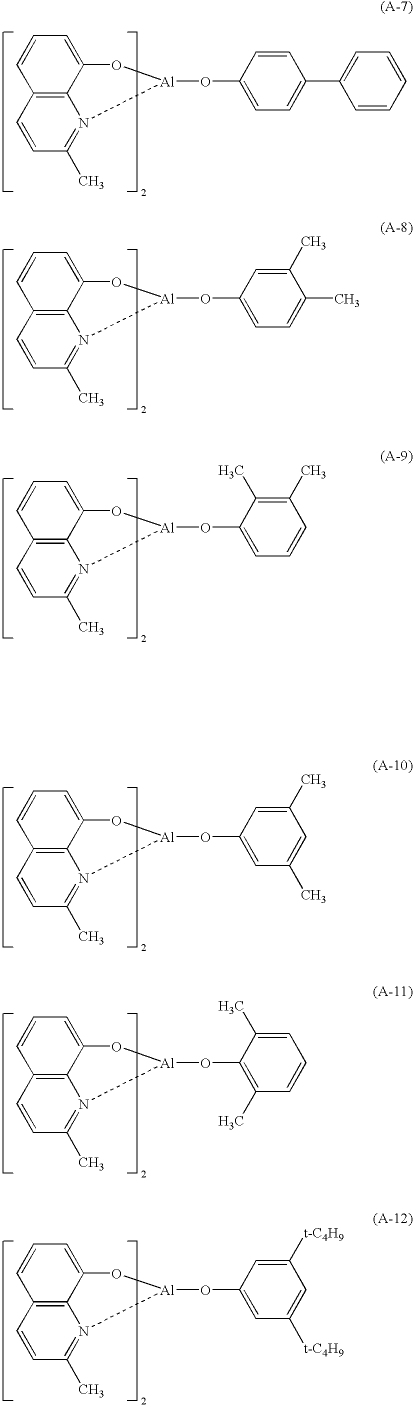

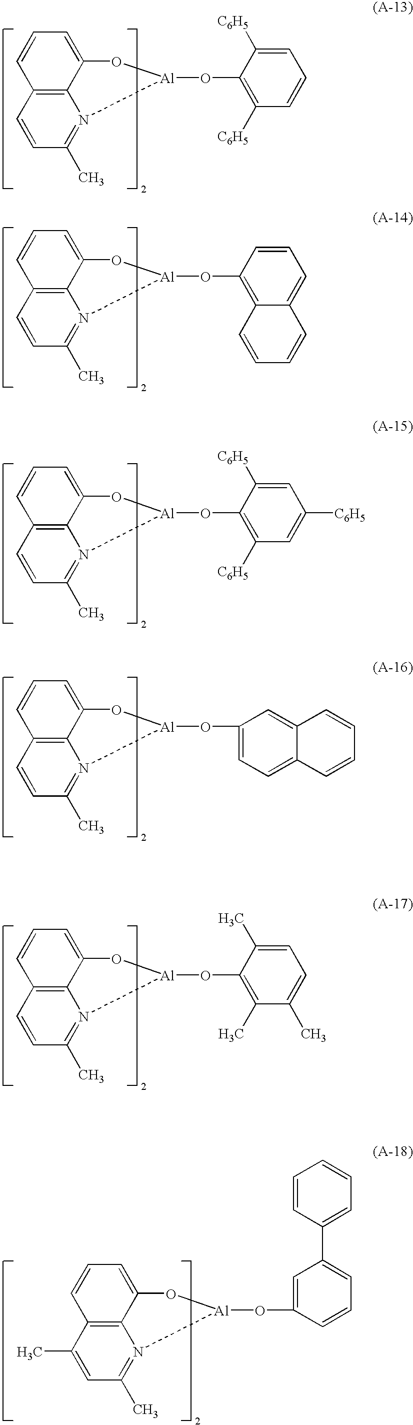

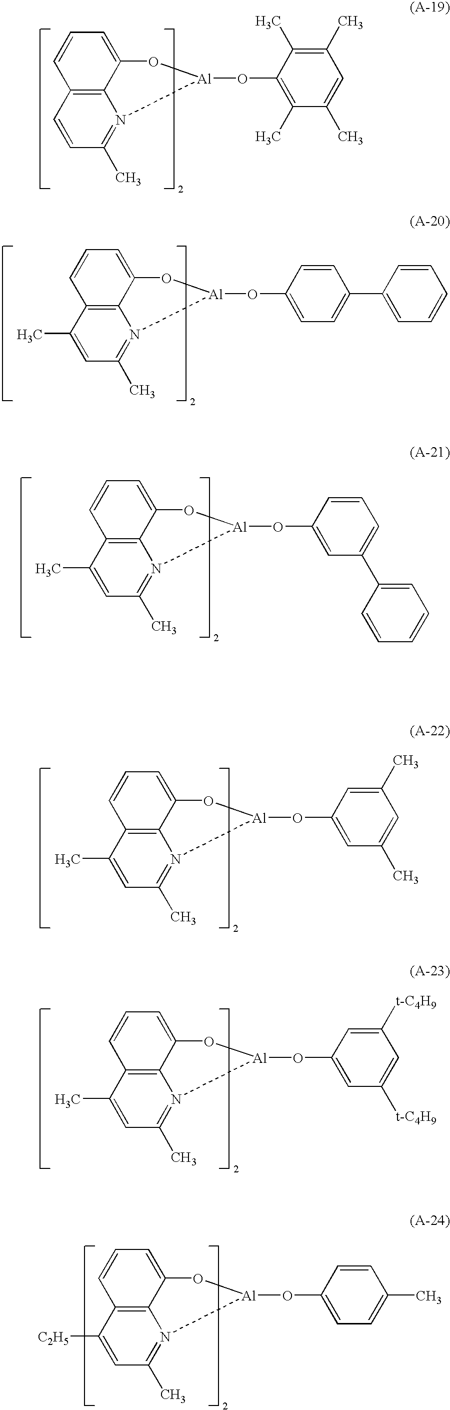

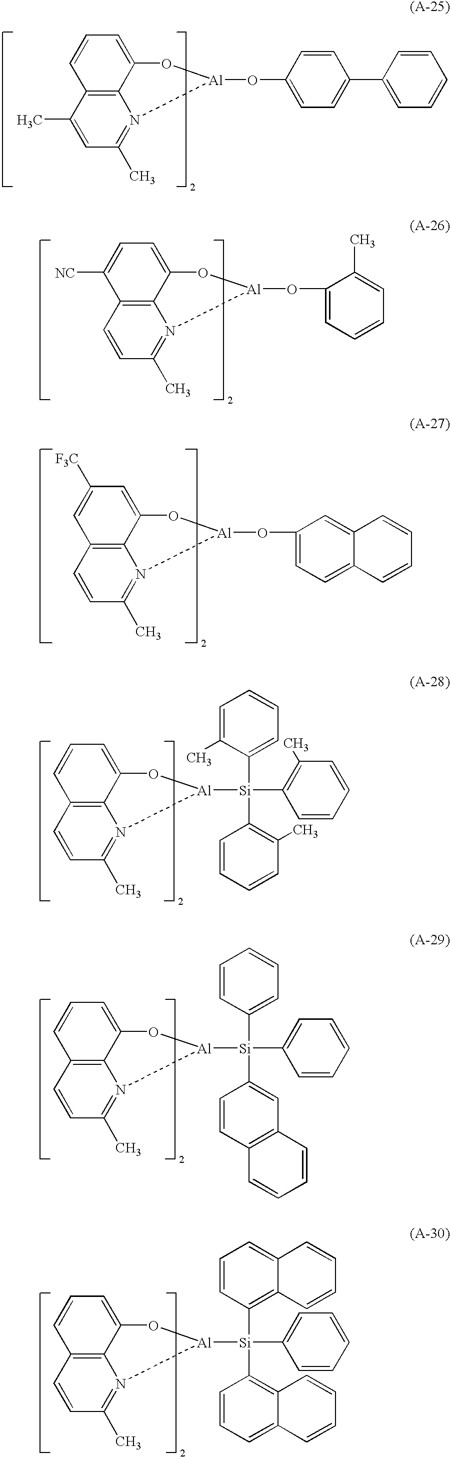

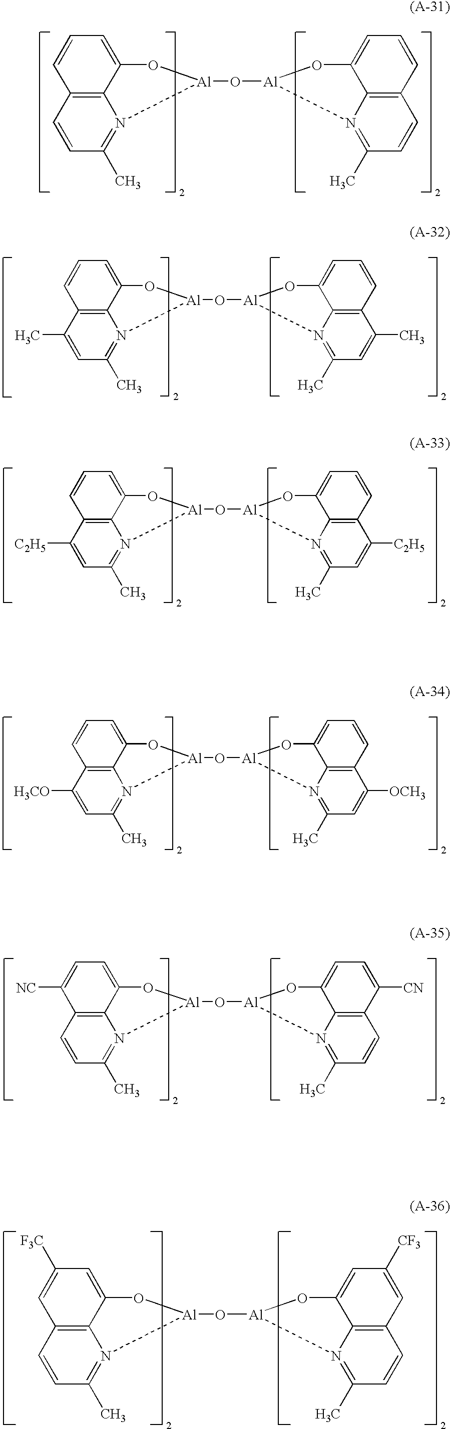

In the organic EL device of the present invention, the above electron injecting layer and/or electron transporting layer contain preferably a π electron deficient nitrogen-containing heterocyclic derivative as a principal component.

The preferred examples of the π electron deficient nitrogen-containing heterocyclic derivative include derivatives of a nitrogen-containing five-membered ring selected from a benzimidazole ring, a benzotriazole ring, a pyridinoimidazole ring, a pyrimidinoimidazole ring and a pyridazinoimidazole ring and nitrogen-containing six-membered ring derivatives constituted from a pyridine ring, a pyrimidine ring, a pyrazine ring and a triazine ring. The nitrogen-containing five-membered ring derivative includes preferably a structure represented by the following Formula B-I. The nitrogen-containing six-membered ring derivative includes preferably structures represented by the following Formulas C-I, C-II, C-III, C-IV, C-V and C-VI. The structures represented by Formulae C-I and C-II are particularly preferred.

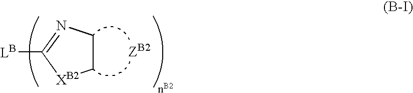

In Formula (B-I), L^{B} represents a divalent or higher linkage group, and it is preferably a linkage group formed from carbon, silicon, nitrogen, boron, oxygen, sulfur, metal and a metal ion, more preferably a carbon atom, a nitrogen atom, a silicon atom, a boron atom, an oxygen atom, a sulfur atom, an aromatic hydrocarbon ring or an aromatic heterocyclic ring and further preferably a carbon atom, a silicon atom, an aromatic hydrocarbon ring or an aromatic heterocyclic ring.

L^{B} may have a substituent. The substituent is preferably an alkyl group, an alkenyl group, an alkynyl group, an aromatic hydrocarbon group, an amino group, an alkoxyl group, an aryloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a sulfonyl group, a halogen atom, a cyano group and an aromatic heterocyclic group, more preferably an alkyl group, an aryl group, an alkoxyl group, an aryloxy group, a halogen atom, a cyano group and an aromatic heterocyclic group, further preferably an alkyl group, an aryl group, an alkoxyl group, an aryloxy group and an aromatic heterocyclic group and particularly preferably an alkyl group, an aryl group, an alkoxyl group and an aromatic heterocyclic group.

The specific examples of the linkage group represented by L^{B} include the following ones:

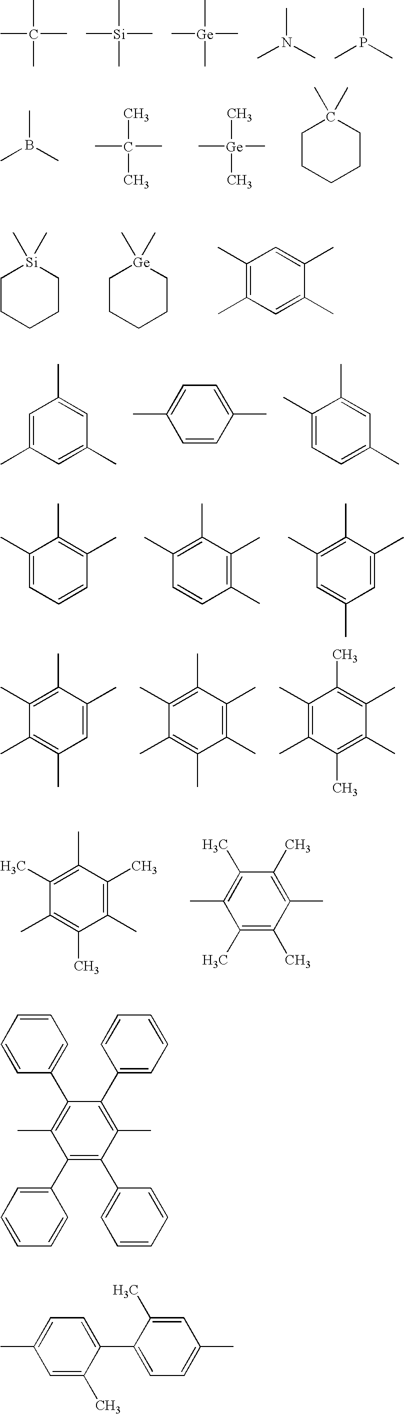

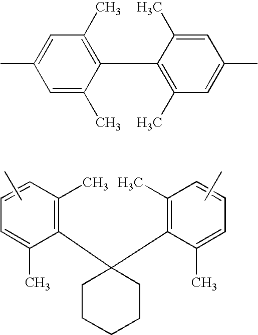

In Formula (B-I), X^{B2} represents —O—, —S— or ═N—R^{B2}. R^{B2} represents a hydrogen atom, an aliphatic hydrocarbon group, an aryl group or a heterocyclic group.

The aliphatic hydrocarbon group represented by R^{B2} is a linear, branched or cyclic alkyl group (an alkyl group having preferably 1 to 20 carbon atoms, more preferably 1 to 12 carbon atoms and particularly preferably 1 to 8 carbon atoms, and it includes, for example, methyl, ethyl, iso-propyl, tert-butyl, n-octyl, n-decyl, n-hexadecyl, cyclopropyl, cyclopentyl and cyclohexyl), an alkenyl group (an alkenyl group having preferably 2 to 20 carbon atoms, more preferably 2 to 12 carbon atoms and particularly preferably 2 to 8 carbon atoms, and it includes, for example, vinyl, allyl, 2-butenyl and 3-pentenyl) or an alkynyl group (an alkynyl group having preferably 2 to 20 carbon atoms, more preferably 2 to 12 carbon atoms and particularly preferably 2 to 8 carbon atoms, and it includes, for example, propargyl and 3-pentynyl), and it is more preferably an alkyl group.

The aryl group represented by R^{B2} is an aryl group of a single ring or a condensed ring, and it is an aryl group having preferably 6 to 30 carbon atoms, more preferably 6 to 20 carbon atoms and further preferably 6 to 12 carbon atoms. It includes, for example, phenyl, 2-methylphenyl, 3-methylphenyl, 4-methylphenyl, 2-methoxyphenyl, 3-trifluoromethylphenyl, pentafluorophenyl, 1-naphthyl and 2-naphthyl.

The heterocyclic group represented by R^{B2} is a heterocyclic group of a single ring or a condensed ring (a heterocyclic group having 1 to 20 carbon atoms, more preferably 1 to 12 carbon atoms and further preferably 2 to 10 carbon atoms), and it is preferably an aromatic heterocyclic group having at least one of a nitrogen atom, an oxygen atom, a sulfur atom and a selenium atom. It includes, for example, pyrrolidine, piperidine, piperazine, morpholine, thiophene, selenophene, furan, pyrrole, imidazole, pyrazole, pyridine, pyrazine, pyridazine, pyrimidine, triazole, triazine, indole, indazole, purine, thiazoline, thiazole, thiadiazole, oxazoline, oxazole, oxadiazole, quinoline, isoquinoline, phthalazine, naphthylidine, quinoxaline, quinazoline, cinnoline, pteridine, acridine, phenanthroline, phenazine, tetrazole, benzimidazole, benzoxazole, benzothiazole, benzotriazole, tetrazaindene, carbazole and azepine. It is preferably furan, thiophene, pyridine, pyrazine, pyrimidine, pyridazine, triazine, quinoline, phthalazine, naphthylidine, quinoxaline or quinazoline, more preferably furan, thiophene, pyridine or quinoline and further preferably quinoline.

The aliphatic hydrocarbon group, the aryl group and the heterocyclic group each represented by R^{B2} may have substituents and include the same substituents as in L^{B}.

R^{B2} is preferably an alkyl group, an aryl group or an aromatic heterocyclic group, more preferably an aryl group or an aromatic heterocyclic group and further preferably an aryl group.

X^{B2} is preferably —O— or ═N—R^{B2}, more preferably ═N—R^{B2} and particularly preferably ═N-13 Ar^{B2} (Ar^{B2} represents an aryl group (an aryl group having preferably 6 to 30 carbon atoms, more preferably 6 to 20 carbon atoms and further preferably 6 to 12 carbon atoms) or an aromatic heterocyclic group (an aromatic heterocyclic group having preferably 1 to 20 carbon atoms, more preferably 1 to 12 carbon atoms and further preferably 2 to 10 carbon atoms), preferably an aryl group).

Z^{B2} represents the group of atoms necessary for forming an aromatic ring. The aromatic ring formed by Z^{B2} may be any of an aromatic hydrocarbon ring and an aromatic heterocyclic ring, and the specific examples thereof include, for example, a benzene ring, a pyridine ring, a pyrazine ring, a pyrimidine ring, a pyridazine ring, a triazine ring, a pyrrole ring, a furan ring, a thiophene ring, a selenophene ring, a tellurophene ring, an imidazole ring, a thiazole ring, a selenazole ring, a tellurazole ring, a thiadiazole ring, an oxadiazole ring and a pyrazole ring. It is preferably a benzene ring, a pyridine ring, a pyrazine ring, a pyrimidine ring or a pyridazine ring, more preferably a benzene ring, a pyridine ring or a pyrazine ring, further preferably a benzene ring or a pyridine ring and particularly preferably a pyridine ring. The aromatic ring formed by Z^{B2} may further form a condensed ring with other rings and may have substituents. The substituents are preferably an alkyl group, an alkenyl group, an alkynyl group, an aryl group, an amino group, an alkoxyl group, an aryloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a sulfonyl group, a halogen atom, a cyano group and a heterocyclic group, more preferably an alkyl group, an aryl group, an alkoxy group, an aryloxy group, a halogen atom, a cyano group and a heterocyclic group, further preferably an alkyl group, an aryl group, an alkoxy group, an aryloxy group and an aromatic heterocyclic group and particularly preferably an alkyl group, an aryl group, an alkoxy group and an aromatic heterocyclic group.

n^{B2} is an integer of 1 to 4 and preferably 2 to 3.

Among the compounds represented by Formula (B-I) described above, compounds represented by the following Formula (B-II) are further preferred:

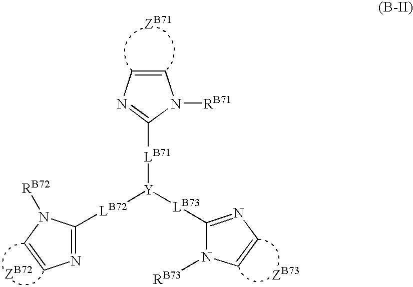

In Formula (B-II), R^{B71}, R^{B72} and R^{B73} each are the same as R^{B2} in Formula (B-I), and the preferred ranges thereof are the same.

Z^{B71}, Z^{B72} and Z^{B73} each are the same as Z^{B72} in Formula (B-I), and the preferable groups are the same.

L^{B71}, L^{B72} and L^{B73} each represent a linkage group and include groups obtained by converting the groups given as the examples of L^{B} in Formula (B-I) into divalent groups, and they are preferably a single bond, a divalent aromatic hydrocarbon cyclic group, a divalent aromatic heterocyclic group or a linkage group comprising a combination of the above groups, more preferably a single bond. L^{B71}, L^{B72} and L^{B73} may have substituents, and the substituent include the same substituents as given for LB in Formula (B-I).

Y represents a nitrogen atom, a 1,3,5-benzenetriyl group or a 2,4,6-triazinetriyl group. The 1,3,5-benzenetriyl group may have substituents at 2-, 4- and 6-positions, and the substituents include, for example, an alkyl group, an aromatic carbocyclic group and a halogen atom.

The specific examples of the nitrogen-containing five-membered ring derivative represented by Formula (B-I) or (B-II) are shown below, but they shall not be limited to these compounds given as the examples.

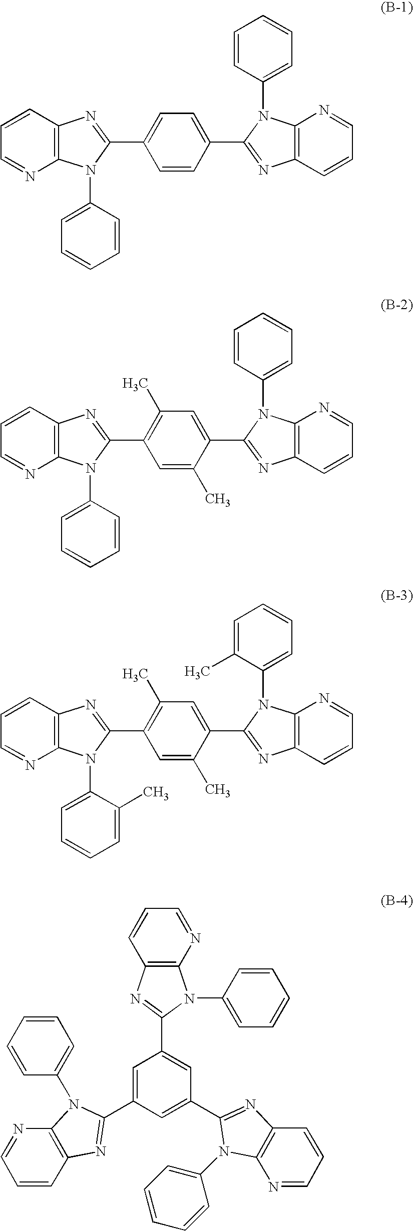

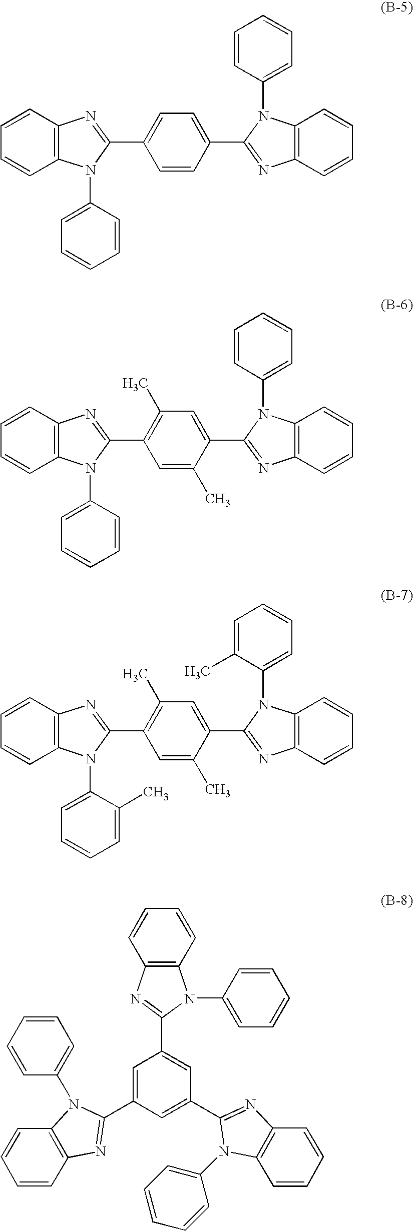

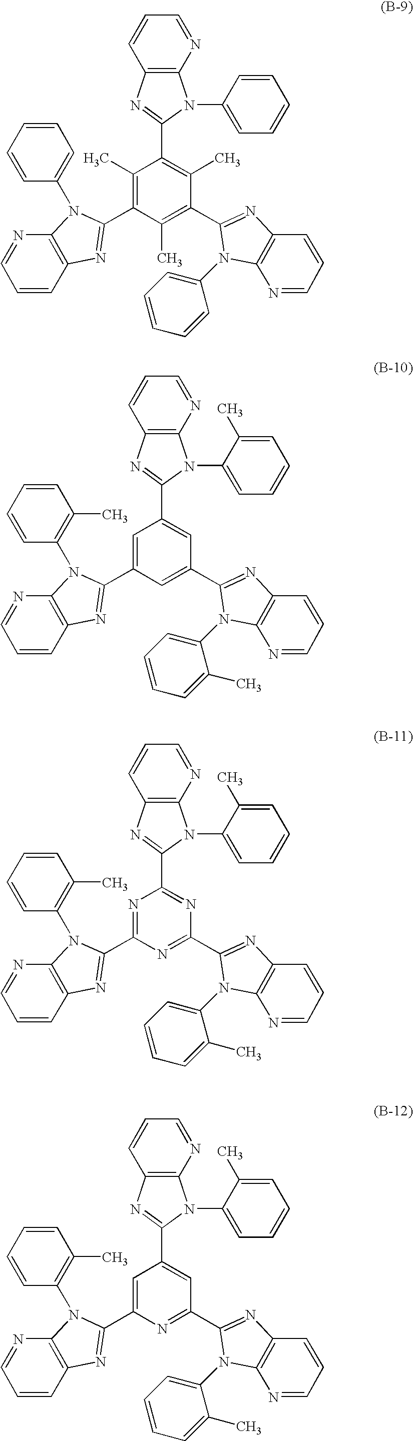

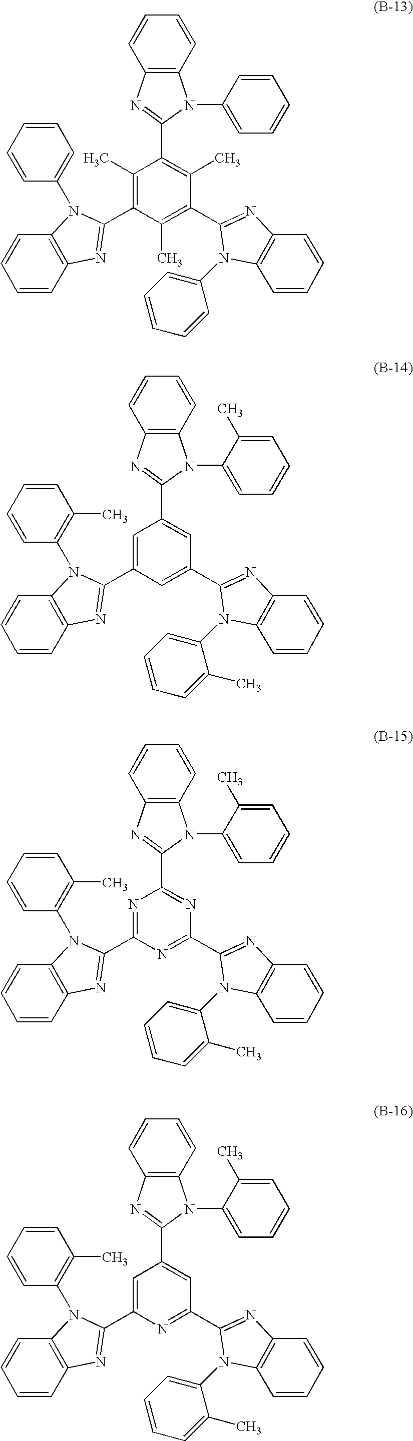

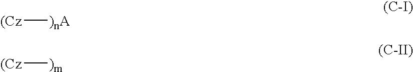

[wherein Cz represents a substituted or unsubstituted carbazolyl group, an arylcarbazolyl group or a carbazolylalkylene group; A represents a group formed from a part represented by the following Formula (A); and n and m each represent an integer of 1 to 3:

(M)ₚ-(L)_{q}-(M′)ᵣ (A)

(M and M′ each represent independently a nitrogen-containing aromatic heterocyclic ring having 2 to 40 carbon atoms which forms a ring, and the ring may have or may not have a substituent; M and M′ may be the same or different; L represents a single bond, an arylene group having 6 to 30 carbon atoms, a cycloalkylene group having 5 to 30 carbon atoms or an aromatic heterocyclic ring having 2 to 30 carbon atoms, and it may have or may not have a substituent bonded to the ring; p represents an integer of 0 to 2; q is an integer of 1 to 2; r is an integer of 0 to 2; and p+r is 1 or more.)]

The bonding modes of Formulas (C-I) and (C-II) each described above are shown according to the numbers of the parameters n and m, to be specific, as described in the following table.

| n = m = 1 | n = 2 | n = 3 | m = 2 | m = 3 |
|---|---|---|---|---|
| Cz—A | Cz—A—Cz | 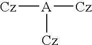 | A—Cz—A | 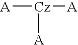 |

The bonding mode of the group represented by Formula (A) is shown according to the numbers of the parameters p, q and r, to be specific, in forms described in (1) to (16) in the following table.

| No | p | q | r | Bonding mode |
|---|---|---|---|---|
| (1) | 0 | 1 | 1 | L—M′ |
| (2) | 0 | 1 | 2 | L—M′—M′, M′—L—M′ |
| (3) | 0 | 2 | 1 | L—L—M′, L—M′—L |
| (4) | 0 | 2 | 2 | L—L—M′—M′, M′—L—L—M′, |
| | | | | 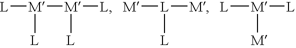 |
| (5) | 1 | 1 | 0 | same as (1) (M′ is replaced by M) |
| (6) | 1 | 1 | 1 | M—L—M′ |
| (7) | 1 | 1 | 2 | 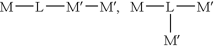 |
| (8) | 1 | 2 | 0 | same as (3) (M′ is replaced by M) |
| (9) | 1 | 2 | 1 | M—L—L—M′, L—M—L—M′, M—L—M′—L |
| (10) | 1 | 2 | 2 | M—L—L—M′, M′—L—M—L—M′, |
| | | | | M′—M′—L—M—L, |
| | | | | 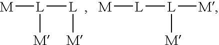 |
| | | | | 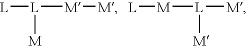 |
| | | | | 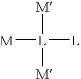 |
| (11) | 2 | 1 | 0 | same as (2) (M′ is replaced by M) |
| (12) | 2 | 1 | 1 | same as (7) (M′ is replaced by M) |
| (13) | 2 | 1 | 2 | M—M—L—M′—M′, |
| | | | | 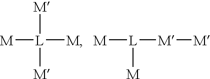 |
| (14) | 2 | 2 | 0 | same as (4) (M′ is replaced by M) |
| (15) | 2 | 2 | 1 | same as (10) (M′ is replaced by M) |
| (16) | 2 | 2 | 2 | M—M—L—L—M′—M′, |
| | | | | 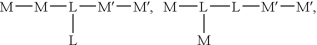 |
| | | | | 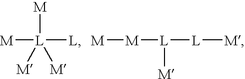 |
| | | | | 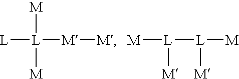 |

When the group represented by Cz is bonded to A in Formulas (C-I) and (V-II) described above, it may be bonded to any position of M, L and M′ representing A. For example, in Cz-A in which m and n are 1, A is M-L-M′ in the case of p=q=r=1 ((6) in the table), and the structure is shown by the three bonding modes of Cz-M-L-M′, M-L(-Cz)-M′ and M-L-M′-Cz. Similarly, for example, in (Cz-A-Cz) in which n is 2 in Formula (C-I), A is M-L-M′-M′ or M-L(-M′)-M′ in the case of p=q=2 and r=1 ((7) in the table), and the structure is shown by the following bonding modes:

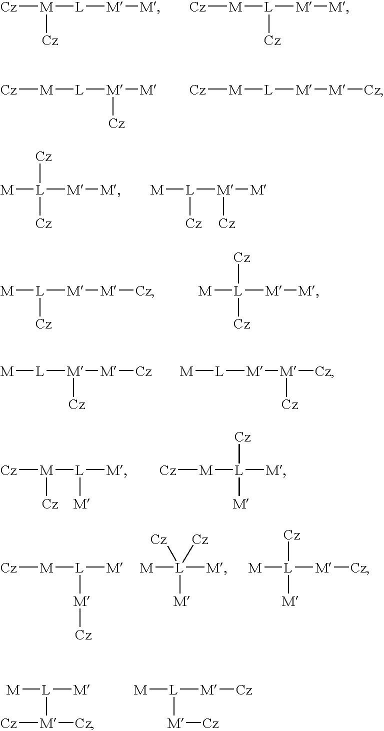

The specific examples of the structures represented by Formulas (C-I) and (C-II) include the following structures, but they shall not be not restricted to these examples.

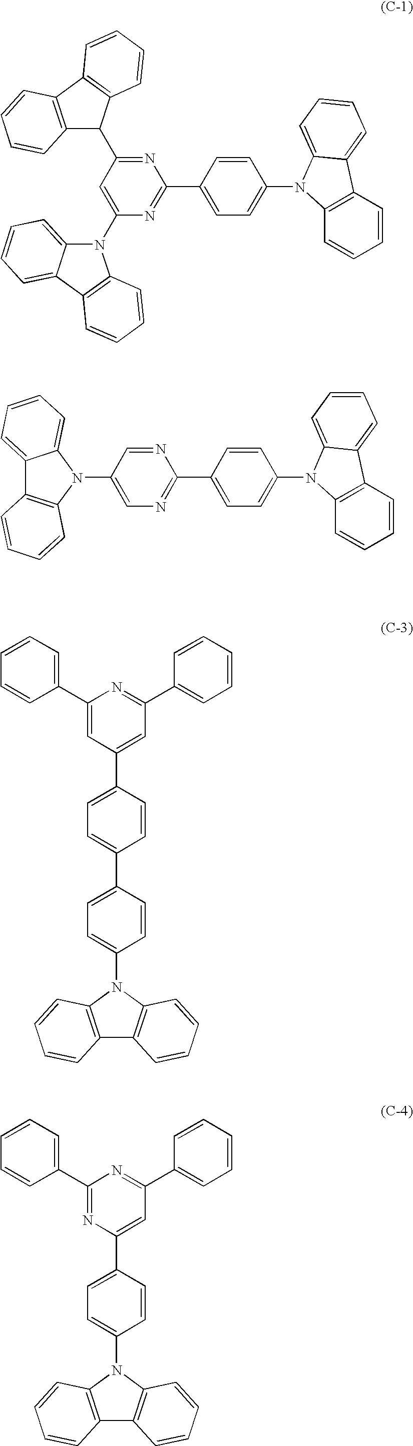

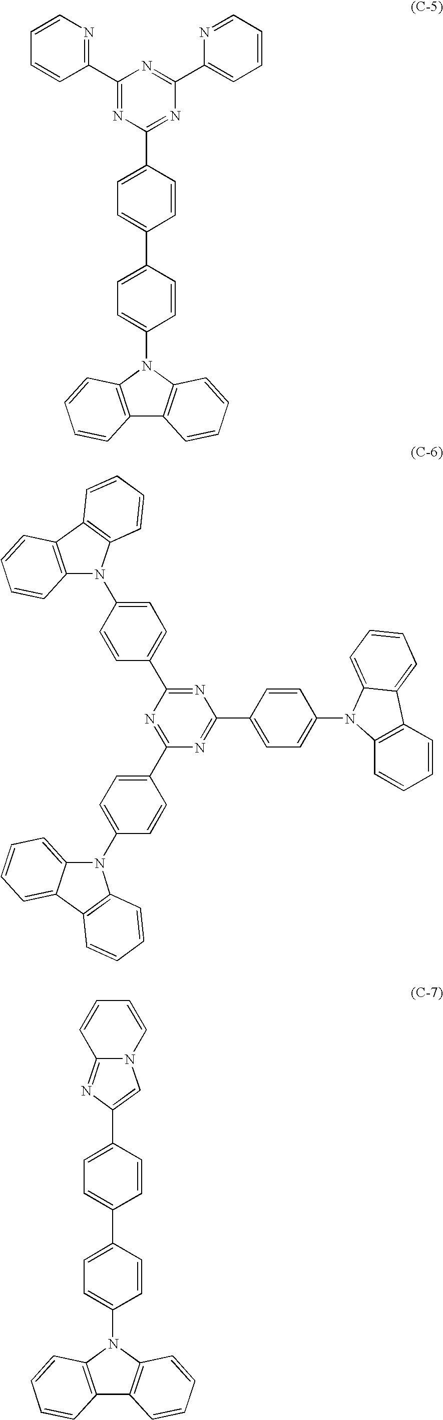

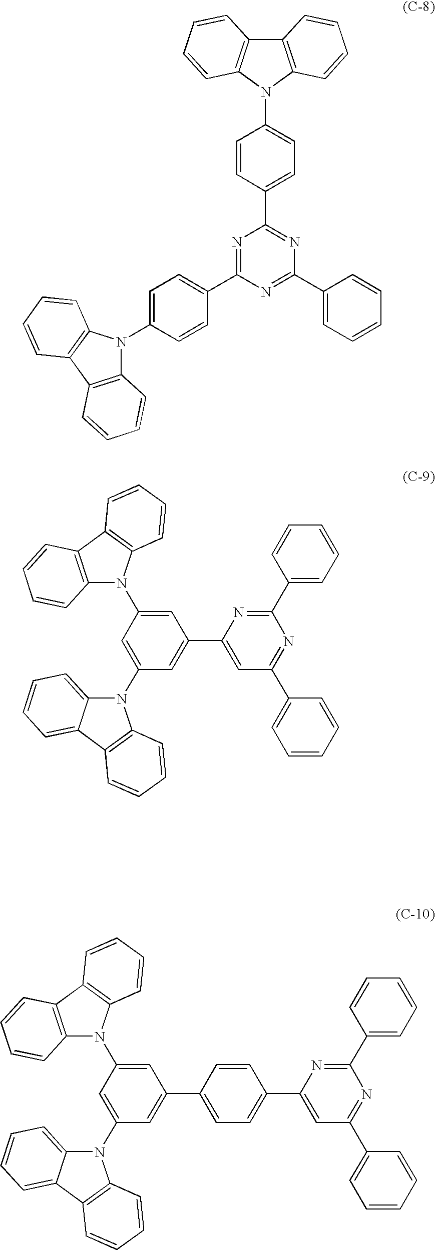

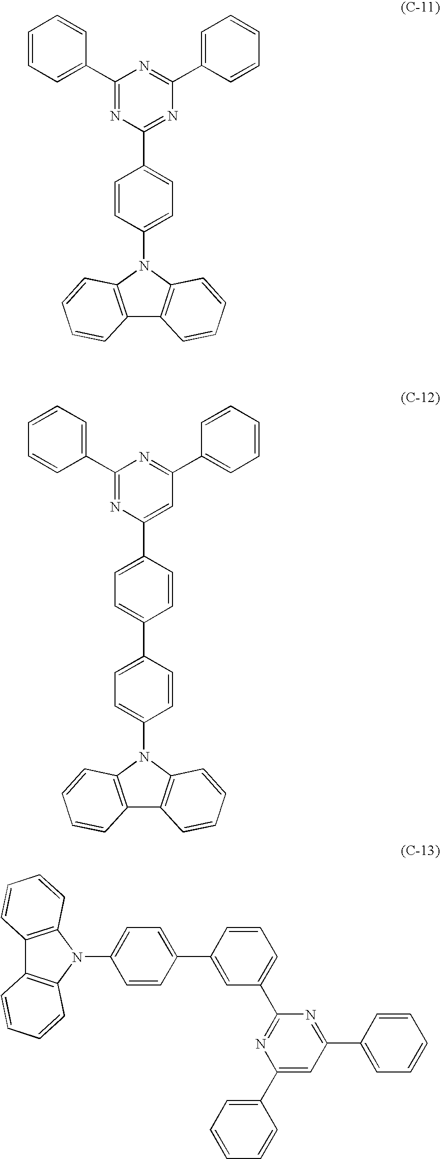

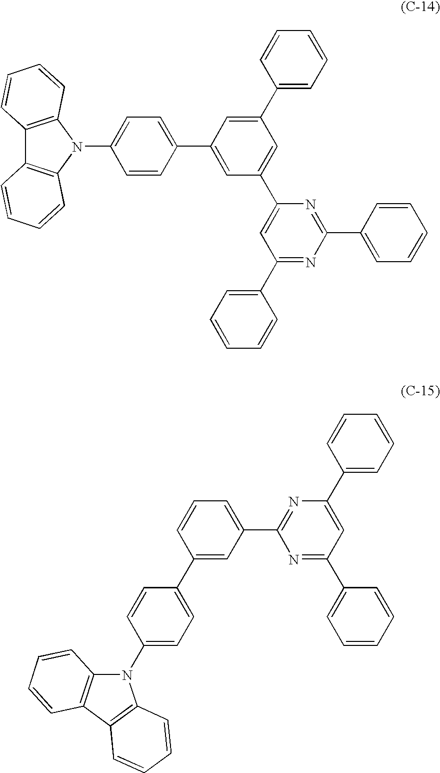

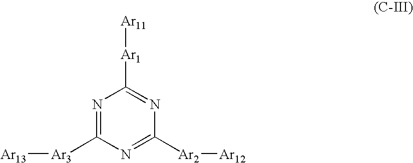

(wherein Ar₁₁ , to Ar₁₃ each represent the same groups as those of R^{B2} in Formula (B-1), and the specific examples thereof are the same; Ar₁ to Ar₃ each represent groups obtained by converting the same groups as those of R^{B2} in Formula (B-1) into divalent groups, and the specific examples thereof are the same).

The specific example of the structure represented by Formula (C-III) is shown below, but it shall not be restricted thereto.

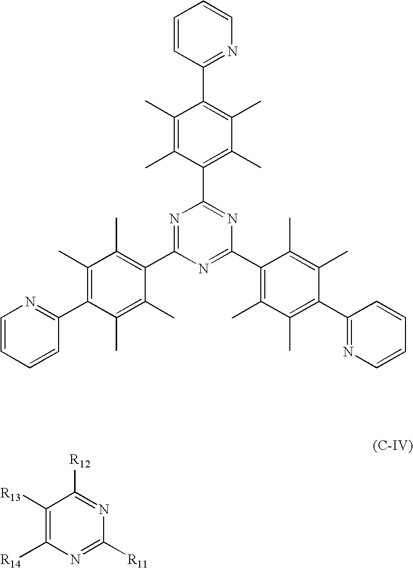

(wherein R₁₁ to R₁₄ each represent the same groups as those of R^{B2} in Formula (B-1), and the specific examples thereof are the same).

The specific example of the structure represented by Formula (C-IV) is shown below, but they shall not be restricted thereto.

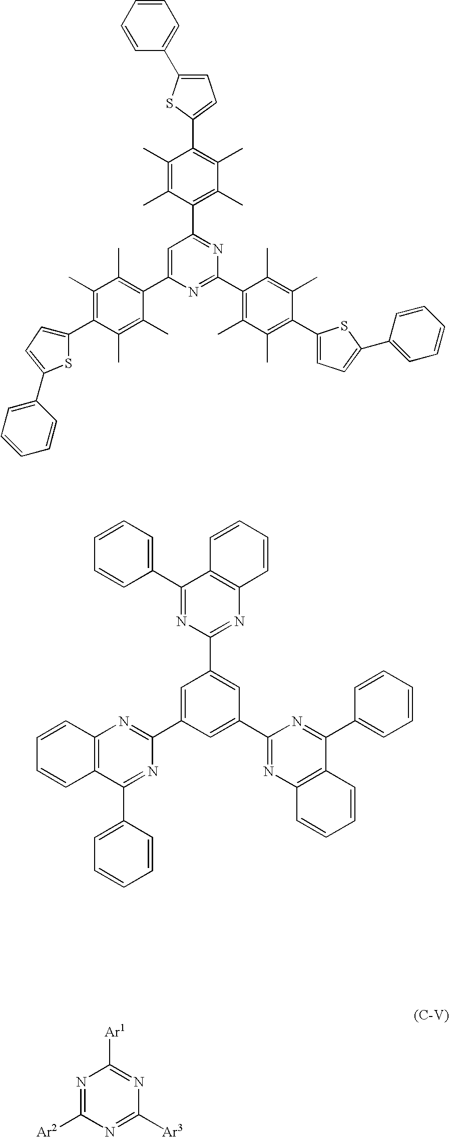

(wherein Ar¹ to Ar³ each represent the same group as those of R^{B2} in Formula (B-1), and the specific examples thereof are the same).

The specific example of the structure represented by Formula (C-V) is shown below, but it shall not be restricted thereto.

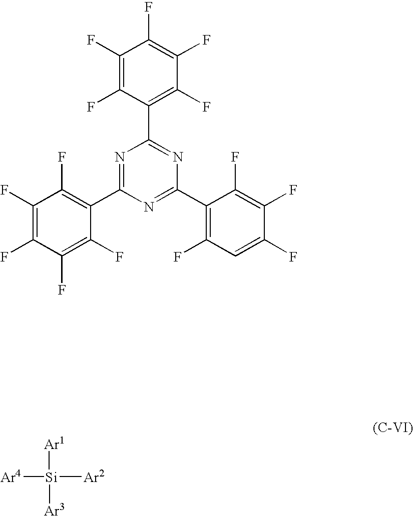

(wherein Ar¹ to Ar³ each represent the same group as those of R^{B2} in Formula (B-1), and the specific examples thereof are the same).

The specific example of the structure represented by Formula (C-VI) is shown below, but it shall not be restricted thereto.

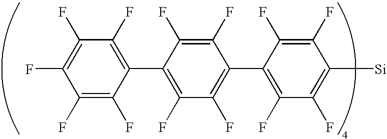

In the organic EL device of the present invention, inorganic compounds of insulating materials or semiconducting materials are preferably used as a material for constituting the electron injecting and transporting layer. If the electron injecting and transporting layer is constituted by an insulating material or a semiconducting material, an electric current can effectively be prevented from leaking to improve the electron injecting property. Preferably used as the above insulating material described above is at least one metal compound selected from the group consisting of chalcogenides of alkali metals, chalcogenides of alkaline earth metals, halides of alkali metals and halides of alkaline earth metals. The electron injecting and transporting layer is preferably constituted by the above chalcogenides of alkali metals since the electron injecting property can be further improved.

To be specific, the preferred chalcogenides of alkali metals include, for example, Li₂O, LiO, Na₂S, Na₂Se and NaO. The preferred chalcogenides of alkaline earth metals include, for example, CaO, BaO, SrO, BeO, BaS and CaSe. Also, the preferred halides of alkali metals include, for example, LiF, NaF, KF, LiCl, KCl and NaCl. The preferred halides of alkaline earth metals include, for example, fluorides such as CaF₂, BaF₂, SrF₂, MgF₂ and BeF₂ and halides other than fluorides.

The semiconducting material constituting the electron injecting and transporting layer includes a single element of oxides, nitrides and oxide nitrides containing at least one element of Ba, Ca, Sr, Yb, Al, Ga, In, Li, Na, Cd, Mg, Si, Ta, Sb and Zn or combinations of two or more kinds thereof. The inorganic compound constituting the electron transporting layer is preferably a fine crystal or amorphous insulating thin film. If the electron transporting layer is constituted by the above insulating thin film, the more homogeneous thin film is formed, and therefore defects in pixels such as dark spots can be reduced. The above inorganic compound includes the chalcogenides of alkali metals, the chalcogenides of alkaline earth metals, the halides of alkali metals and the halides of alkaline earth metals each described above.

Further, in the organic EL device of the present invention, the electron injecting layer and/or the electron transporting layer may contain a reducing dopant having a work function of 2.9 eV or less. In the present invention, the reducing dopant is a compound which elevates an efficiency of injecting electrons.

Also, in the present invention, the reducing dopant is preferably added to an interfacial region between the cathode and the organic thin film layer, and at least a part of the organic layer contained in the interfacial region is reduced and converted into an anion. The preferred reducing dopant is at least one compound selected from the group consisting of alkaline metals, oxides of alkaline earth metals, alkaline earth metals, rare earth metals, oxides of alkaline metals, halides of alkaline metals, oxides of alkaline earth metals, halides of alkaline earth metals, oxides of rare earth metals or halides of rare earth metals, alkali metal complexes, alkaline earth metal complexes and rare earth metal complexes. To be more specific, the preferred reducing dopant includes at least one alkali metal selected from the group consisting of Na (work function: 2.36 eV), K (work function: 2.28 eV), Rb (work function: 2.16 eV) and Cs (work function: 1.95 eV) and at least one alkaline earth metal selected from the group consisting of Ca (work function: 2.9 eV), Sr (work function: 2.0 to 2.5 eV) and Ba (work function: 2.52 eV), and compounds having a work function of 2.9 eV are particularly preferred. Among them, the reducing dopant is more preferably at least one alkali metal selected from the group consisting of K, Rb and Cs, further preferably Rb or Cs and most preferably Cs. These alkali metals have a particularly high reducing ability, and addition of a relatively small amount thereof to the electron injecting zone enhances an emission luminance and elongates a life in the organic EL device.

The preferred ones out of the alkaline earth metal oxides described above include, for example, BaO, SrO, CaO and BaₓSr₁₋ₓO (0≦x≦1) and BaₓCa₁₋ₓ. (0≦x≦1) which are obtained by mixing the above compounds. The oxides or fluorides of alkaline metals include LiF, Li₂O, NaF and the like. The alkaline metal complexes, the alkaline earth metal complexes and the rare earth metal complexes shall not specifically be restricted as long as they contain at least one metal ion of alkaline metal ions, alkaline earth metal ions and rare earth metal ions. The ligand includes, for example, quinolinol, benzoquinolinol, acrydinol, phenanthridinol, hydroxyphenyloxazole, hydroxyphenylthiazole, hydroxydiaryloxadiazole, hydroxydiarylthiadiazole, hydroxyphenylpyridine, hydroxyphenylbenzimidazole, hydroxybenzotriazole, hydroxylfurborane, bipyridyl, phenanthroline, phthalocyanine, porphyrin, cyclopentadiene, β-diketones, azomethines and derivatives thereof. However the ligand shall not be restricted to the above compounds.

The preferred shape of the reducing dopant is constituted in the form of a layer or an island. When used in the form of a layer, a preferred thickness thereof is 0.05 to 8 nm.

A for forming the electron injecting and transporting layer containing the reducing dopant is preferably a method in which while the reducing dopant is deposited by a resistance heating deposition method, a luminescent material for forming the interfacial region or an organic substance as an electron injecting material is deposited at the same time to disperse the reducing dopant in the organic substance. A dispersion concentration thereof is 100:1 to 1:100, preferably 5:1 to 1:5 in terms of a mole ratio. When the reducing dopant is constituted in the form of a layer, the luminescent material or the electron injecting material which is the organic layer in the interface is constituted in the form of a layer, and then the reducing dopant is deposited alone by the resistance heating deposition method to constitute the layer preferably in a thickness of 0.5 to 15 nm. When the reducing dopant is constituted in the form of an island, the luminescent material or the electron injecting material which is the organic layer in the interface is constituted in the form of an island, and then the reducing dopant is deposited alone by the resistance heating deposition method to constitute the islands preferably in a thickness of 0.05 to 1 nm.

The luminescent layer in the organic EL device of the present invention has the function of making it possible to inject holes from the anode or the hole injecting layer and making it possible to inject electrons from the cathode or the electron injecting layer when an electric field is applied, the function of transferring charges injected (electrons and holes) by virtue of the force of the electric field and the function of providing a field for recombination of electrons and holes to lead this to light emission. The luminescent layer in the organic EL device of the present invention contains preferably at least the transition metal complex compound of the present invention and may contain a host material using the above transition metal complex compound as a guest material. The host material described above includes, for example, materials having a carbazole skeleton, materials having a diarylamine skeleton, materials having a pyridine skeleton, materials having a pyrazine skeleton, materials having a triazine skeleton and materials having an arylsilane skeleton. T1 (an energy level of a minimum triplet excited state) of the host material described above is preferably larger than a T1 level of the guest material. The host material described above may be a low molecular compound or a high molecular compound. A luminescent layer in which the luminescent material described above is doped with the host material can be formed by co-depositing the host material described above and the luminescent material such as the transition metal complex compound described above.

In the organic EL device of the present invention, methods for forming the respective layers described above shall not specifically be restricted, and capable of being used are various methods such as a vacuum deposition method, an LB method, a resistance heating deposition method, an electron beam method, a sputtering method, a molecular accumulation method, a coating method (a spin coating method, a casting method and a dip coating method), an ink jet method and a printing method. In the present invention, the coating method is preferred.

The organic thin film layer containing the transition metal complex compound of the present invention can be formed by a publicly known method such as a vacuum deposition process, a molecular beam epitaxy method (an MBE method) or a dipping method using a solution prepared by dissolving the compound in a solvent, a spin coating method, a casting method, a bar coating method and a roll coating method.

In the coating method described above, the transition metal complex compound of the present invention is dissolved in a solvent to prepare a coating liquid, and the above coating liquid is applied on a desired layer (or an electrode) and dried, whereby the layer can be formed. A resin may be contained in the coating liquid, and the resin can assume a dissolving state or a dispersing state in the solvent. Non-conjugated polymers (for example, polyvinyl carbazole) and conjugated polymers (for example, polyolefin base polymers) can be used as the resin. To be more specific, the resin includes, for example, polyvinyl chloride, polycarbonate, polystyrene, polymethyl methacrylate, polybutyl methacrylate, polyester, polysulfone, polyphenylene oxide, polybutadiene, poly(N-vinylcarbazole), hydrocarbon resins, ketone resins, phenoxy resins, polyamides, ethyl cellulose, vinyl acetate, ABS resins, polyurethane, melamine resins, unsaturated polyester resins, alkyd resins, epoxy resins and silicone resins.

The film thicknesses of the respective organic layers in the organic EL device of the present invention shall not specifically be restricted. In general, the too small thickness is liable to cause defects such as pinholes. On the other hand, the too large thickness requires a high voltage applied to deteriorate the efficiency, and therefore the preferred range is usually several nm to 1 μm.

### EXAMPLES

Next, the present invention shall be explained in further details with reference to examples.

### Example 1

### Synthesis of Transition Metal Complex Compound 1

### (i) Synthesis of Compound a

A compound a was synthesized by the following reaction step according to a method described in a reference document (Chem. Pharm. Bull., 1965, 13, 1135):

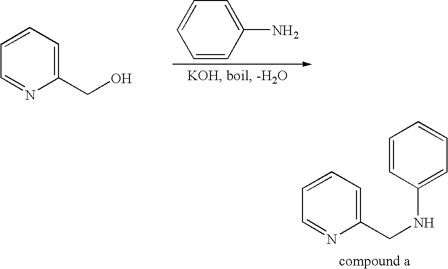

2-Pyridinemethanol 25.6 g (0.239 mole), aniline 20.3 ml (0.214 mole) and potassium hydroxide 1.92 g (0.0341 mole) were heated and stirred in a Kjeldahl flask at 150° C. for 12 hours. As a result thereof, the solution was changed from a pale yellow oily state to a pale yellow suspension state. This was cooled down to room temperature, and 200 ml of water was added, followed by neutralizing the solution to pH 7 to 8 by diluted hydrochloric acid. Next, 500 ml of methylene chloride was added to this reaction solution, and an organic layer was extracted by means of a separating funnel. Further, the solution was extracted four times with 100 ml of methylene chloride. This solution was dehydrated on potassium carbonate, and a solid component was filtered off. The solvent was distilled off under reduced pressure, whereby a yellowish brown paste-like solid matter was obtained. This paste-like solid matter was subjected to vacuum distillation to thereby obtain 7.70 g (0.0417 mole, yield: 18%) of a reddish orange oil. The distillation temperature was 115° C. at 1 mm Hg. ¹H-NMR of the above reddish orange oil was measured to result in finding that the principal component was the targeted compound a.

¹H-NMR (apparatus: <apparatus name Varian MERCURY 300> 300 MHz, solvent: heavy chloroform, internal reference: TMS 0.00 ppm, temperature: 35° C.): δ 4.45 (s, 2H, CH₂), δ 4.73 (br, 1H, NH), δ 6.65 to 7.24 (m, 5H, benzene ring), δ 7.18 to 8.58 (m, 5H, pyridine ring)

### (ii) Synthesis of Compound b

A compound b was synthesized according to the following reaction step:

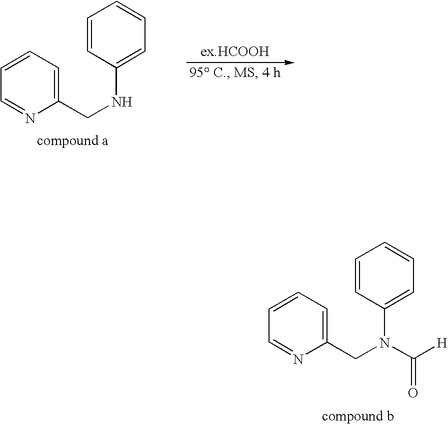

The compound a synthesized in (i) described above was used to synthesize a compound b. The compound a 2.82 g (0.0153 mole) and formic acid 2.90 g (0.0765 mole) were added in the presence of molecular sieves, and the mixture was stirred at 95° C. for 4 hours. This was cooled down to room temperature, and 100 ml of water was added thereto, followed by extracting the solution with methylene chloride (five times each by 50 ml). Magnesium sulfate was added to this solution to dehydrate it, and a solid component was filtered off. Then, the solvent was distilled off under reduced pressure to obtain a brown oil. Next, this was refined by means of silica gel column chromatography (developing solvent: hexane/ethyl acetate=1/1) to result in obtaining 2.06 g of a dark reddish brown oil (yield: 63%, Rf value: 0.7). ¹H-NMR thereof was measured to result in finding that the targeted compound b was obtained.

¹H-NMR (apparatus: <apparatus name Varian MERCURY 300> 300 MHz, solvent: heavy chloroform, internal reference: TMS 0.00 ppm, temperature: 35° C.): δ 5.18 (s, 2H, CH₂), δ 7.14 to 7.38 (m, 5H, benzene ring), δ 7.14 to 8.54 (m, 4H, pyridine ring), δ 8.65 (s, 1H, aldehyde)

(iii) Synthesis of Compound c

A compound c was synthesized according to the following reaction step:

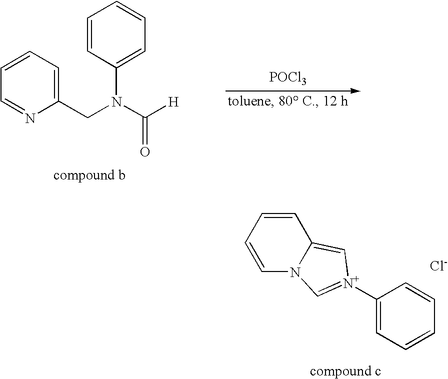

The compound b synthesized in (ii) described above was used to synthesize a compound c. The compound b 1.03 g (4.85 millimole), phosphorus oxychloride 0.50 ml (5.34 millimole) and toluene 10 ml were put in a Kjeldahl flask, and the mixture was heated and stirred at 80° C. for 12 hours (separated into two layers). This solution was distilled off under reduced pressure to obtain 1.97 g of a greenish grey solid matter as a crude product. Methylene chloride 40 ml was added to 0.602 g of this crude product and sufficiently stirred, and then a solid component was removed by means of a centrifugal separator to obtain a greenish brown solution. This was concentrated to 5 ml in terms of a solution volume, and 50 ml of diethyl ether was added thereto while stirring to find that a pale green precipitate was produced. This was separated and dried. Peaks were identified by means of ¹H-NMR and H—H COSY to find that this was the targeted compound c (0.287 g, yield: 83%). The measuring result of ¹H-NMR is shown in FIG. 1.

¹H-NMR (apparatus: <apparatus name Varian MERCURY 300> 300 MHz, solvent: heavy chloroform, internal reference: TMS 0.00 ppm, temperature: 35° C.): δ 7.07 (dd, J=7.1, 6.6 Hz, 1H, H^{c}), 7.24 (dd, J=9.3, 6.6 Hz, 1H, H^{d}), 7.56 to 7.84 (m, 5H, H^{g,h,i}), 7.70 (d, J=9.3 Hz, 1H, H^{e}), 8.09 (s, 1H, H^{f}), 9.14 (d, J=7.1 Hz, 1H, H^{b}) 11.38 (s, 1H, H^{a})

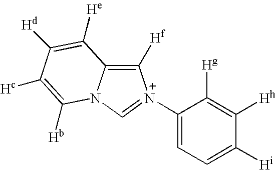

### (iv) Synthesis of Compound d

A compound d was synthesized according to the following reaction step:

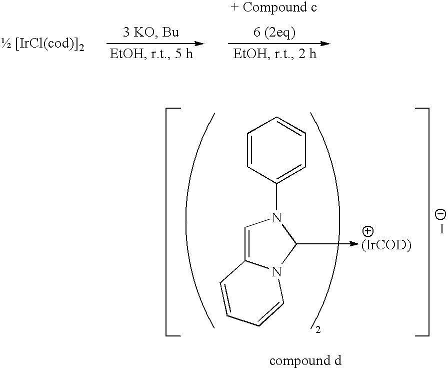

[(COD)IrCl]₂ ((cyclooctadiene)iridium chloride dimer) 0.154 g (0.229 millimole), KOₜBu (potassium tertiary butoxide) 0.154 g (1.37 millimole) and a solvent ethanol 5.0 ml were put in a Schlenk tube of 20 ml under argon flow, and the mixture was stirred at room temperature for 5 hours. Then, 0.211 g (0.915 millimole) of the compound c was added thereto, and the mixture was stirred at room temperature for 2 hours. Next, the solvent was distilled off under reduced pressure, and a reddish orange solid matter obtained was dissolved in methylene chloride. A white solid matter was filtered off, and the solvent was distilled off from the methylene chloride-soluble part under reduced pressure, whereby 0.290 g (yield: 87%) of the targeted product (reddish orange solid matter) was obtained. The measuring result of ¹H-NMR is shown in FIG. 2.

### (v) Synthesis of Transition Metal Complex (Compound 1)

A compound 1 was synthesized according to the following reaction step:

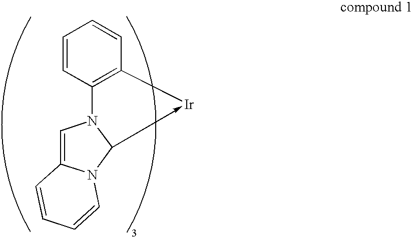

The compound d 202 mg (0.278 millimole) and deaerated 2-ethoxyethanol 15.0 ml were put in a Schlenk bottle under argon atmosphere, and a reflux tube was installed to reflux the solution on an oil bath for 2 hours. The solution was changed from a reddish orange solution to a brown suspension.

The suspension was cooled down to room temperature, and 187 mg (1.67 millimole) of potassium tertiary butoxide was added thereto and stirred at room temperature for 3 hours. Then, 128 mg (0.555 millimole) of the compound c was added thereto, and a reflux tube was installed to reflux the solution on an oil bath for 2 hours. The solution was changed to a slightly reddish brown suspension.

The solvent was distilled off under reduced pressure, and then this was subjected to column chromatography (developing solvent: methylene chloride, Rf value: 0.91) under aerial atmosphere. The solvent was distilled off under reduced pressure and dried up to obtain 35.2 mg (yield: 16.4%) of a crude product of a pale yellowish green solid matter.

The solvent was further distilled off from the above crude product, and this was refined by column chromatography under argon atmosphere using a deaerated solvent (methylene chloride:hexane=1:1) to result in obtaining 8.2 mg (yield: 3.8%) of a pale yellow solid matter. The measuring result of ¹H-NMR is shown in FIG. 3.

The compound thus obtained was subjected to measurements of (1) to (3) shown below on the same conditions as in Example 1.

### <Results of Various Measurements>

(1) EI-MS measurement (electron ionization mass spectrometry): a maximum peak value was 772 and agreed with a calculated value (M⁺) (calculated value M⁺=772).
(2) Measurement of ¹H-NMR (300 MHz) spectrum: refer to FIG. 3

### Apparatus: Varian MERCURY 300

Measuring solvent: solvent CD₂Cl₂ (deuterated methylene chloride), reference 5.32 ppm

The structure of the compound 1 was identified by the results of (1) and (2) described above.

Further, an emission spectrum of the compound 1 was measured (apparatus: fluorescent spectrophotometer Hitachi F-4500, measuring solvent: methylene chloride) to find that maximum emission wavelengths were observed at 388 nm, 409 nm and 435 nm.

### Example 2

### Synthesis of Transition Metal Complex Compound 1

### (i) Synthesis of Compound e

A compound e was synthesized according to the following reaction step:

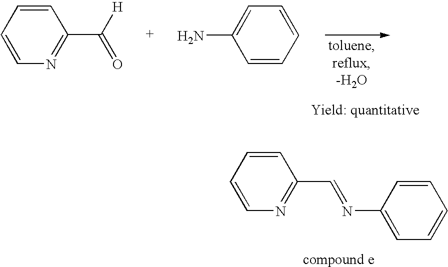

Toluene 50 ml, 2-pyridinecarboxyaldehyde 9.55 ml (0.100 mole, 1.0 eq) and aniline 9.13 ml (0.100 mole, 1.0 eq) were put in a Kjeldahl flask, and as soon as stirring was started, a pale yellow solid matter was produced. Stirring was further continued, and all the solid matter was dissolved to obtain a colorless solution. After stirred at room temperature for 24 hours, the solvent was distilled off under reduced pressure to obtain quantitatively a pale yellow oily compound e. The measuring result of ¹H-NMR is shown below.

¹H-NMR (solvent: CDCl₃, internal reference: TMS 0.00 ppm, 300 MHz, temperature: 35° C.): δ 7.28 to 7.45 (m, 5H, H^{Ph}), 7.37 (ddd, J=7.7, 4.7, 1.1 Hz, 1H, H_{b}), 7.82 (ddd, J=7.7, 7.7, 1.9 Hz, 1H, H_{c}), 8.21 (dd, J=7.7, 1.9 Hz, 1H, H_{d}), 8.62 (s, 1H, Hₑ), 8.72 (dd, J=7.7, 1.1 Hz, 1H, Hₐ)

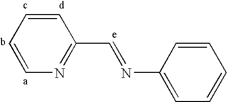

### (ii) Synthesis of Compound c

A compound c was synthesized according to the following reaction step:

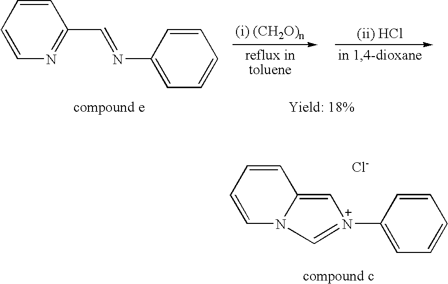

The compound e 1.82 g (10.0 mmol), granular paraformaldehyde ((CH₂O)ₙ, contained in 91%) 0.328 g (12.0 mmol) which was finely crushed in advance and toluene 50 ml were put in a Kjeldahl flask and stirred at room temperature for 24 hours to completely dissolve (CH₂O)ₙ in toluene. Then, 2.8 ml (11.0 mmol) of hydrochloric acid (4M, 1,4-dioxane solution) was added thereto, and the solution was stirred at room temperature for one day. A yellow solid matter was started to be deposited from the moment that the hydrochloric acid solution was added.

An orangish brown solid matter obtained by distilling the solvent off under reduced pressure was subjected to celite filtering with CH₂Cl₂, and the filtrate was dried up under reduced pressure to obtain a crude product of a pale yellow solid matter. This was recrystallized from hot acetone to thereby refine a pale yellowish brown compound c (0.411 g, yield: 18%).

¹H-NMR and MS (FAB⁺) (FAB-MS: high speed electron impact method mass spectrum, apparatus: FAB-MS: JEOL JMS-700 Mass spectrometer (using 3-nitrobenzyl alcohol as a matrix) thereof were measured to result in finding that it was the targeted compound e.

Compound c ¹H-NMR (CDCl₃, 300 MHz, 35° C.): δ 7.07 (dd, J=7.1, 6.6 Hz, 1H, H^{c}), 7.24 (dd, J=9.3, 6.6 Hz, 1H, H^{d}), 7.56 to 7.84 (m, 5H, H^{Ph}), 7.70 (d, J=9.3 Hz, 1H, Hₑ), 8.09 (s, 1H, H^{f}), 9.14 (d, J=7.1 Hz, 1H, H^{b}), 11.38 (s, 1H, H^{a}),

MS (FAB⁺): m/z=195.1 (M-Cl⁻)

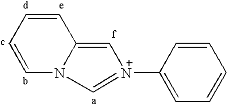

(iii) Synthesis of Compound f

A compound f was synthesized according to the following reaction step:

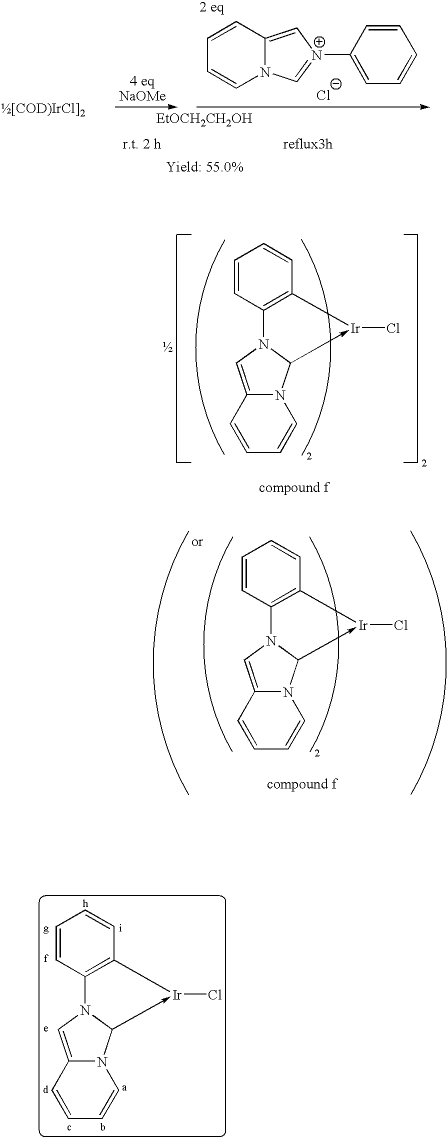

[(COD)IrCl]₂ 672 mg (1.00 mmol), NaOMe 432 mg (8.00 mmol) and deaerated 2-ethoxyethanol 50 ml were put in a Schlenk bottle under argon atmosphere, and the mixture was stirred at room temperature for 2 hours (yellow solution). Then, 923 mg (4.00 mmol) of the ligand precursor compound c was added thereto, and a reflux tube was installed to reflux the solution on an oil bath for 3 hours. The solution was changed from a reddish orange solution to a brown suspension.

The solvent was distilled off under reduced pressure, and then this was refined by column chromatography using a deaerated solvent (CH₂Cl₂) and silica gel to obtain a product of a yellow solid matter 676 mg (0.550 mmol, yield: 55.0%).

¹H-NMR, ¹³C-NMR and MS (FAB⁺) (FAB-MS: high speed electron impact method mass spectrum) thereof were measured to result in finding that it was the targeted compound f.

Compound f ¹H-NMR (CD₂Cl₂, 300 MHz, 25° C.): δ 5.84 (d, J=7.4 Hz, 1H, Hⁱ), 5.86 (dd, J=7.1, 6.8 Hz, 1H, H^{b}), 6.38 (dd, J=7.4, 7.0, 1H, H^{h}), 6.60 (dd, J=8.8, 6.8 Hz, 1H, H^{c}), 6.78 (dd, J=7.4, 7.0 Hz, 1H, H^{g}), 7.21 (d, J=8.8, Hz, 1H, H^{f}), 7.21 (d, J=7.4, Hz, 1H, H^{d}), 7.82 (s, 1H, H^{e}), 9.18 (d, J=7.1 Hz, 1H, H^{a}).

Compound f ¹³C-NMR (CD₂Cl₂, 75 MHz, 25° C.): δ 104.2, 111.1, 111.9, 116.9, 120.8, 121.4, 125.2, 125.3, 129.7, 130.7, 136.4, 146.0, 165.4

MS (FAB⁺): m/z=1228.2 (M⁺)

Beilstein test: positive

(Beilstein test: copper chloride is produced by bringing a heated copper wire into contact with a compound containing chlorine, and flame reaction of a bluish green color can be confirmed).

### (iv) Synthesis of Transition Metal Complex (Compound 1)

The compound 1 was synthesized according to the following reaction step:

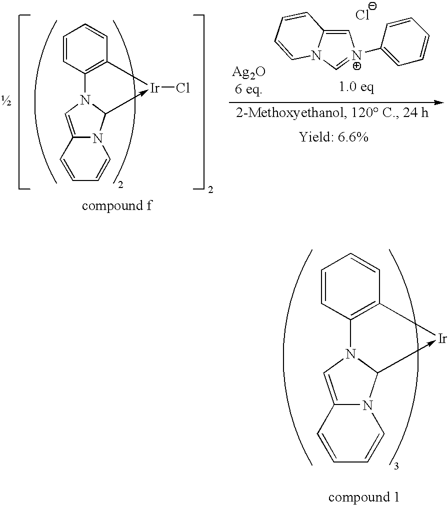

The compound f 61.4 mg (0.0500 mmole), silver oxide (I) (Ag₂O (I)) 139 mg (0.600 mmole), the compound c 23.1 mg (0.100 mmole) and 2-ethoxyethanol (deaerated solvent) 20 ml were put in a Schlenk bottle under argon atmosphere, and it was shielded from light with an aluminum foil and stirred at 120° C. for 24 hours. The resulting brownish red suspension was subjected to celite filtering (CH₂Cl₂) under argon atmosphere to remove residual Ag₂O and silver chloride (AgCl), and it was further refined by column chromatography using a deaerated solvent (methylene chloride (CH₂Cl₂):hexane=1:1) and silica gel. The solvent was distilled off under reduced pressure to obtain 5.1 mg (0.0066 mmol, yield: 6.6%) of a pale yellow solid matter.

The measuring result of ¹H-NMR is shown in FIG. 4. It is considered from a peak splitting pattern and an integrated intensity ratio that the product comprises a mer body as a principal component.

### Example 3

### Synthesis of Transition Metal Complex Compound 1

The compound 1 was synthesized according to the following reaction step:

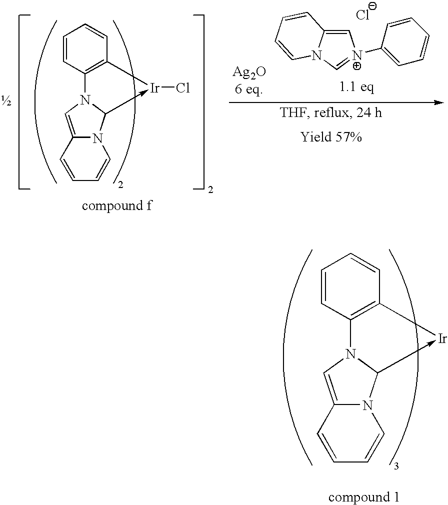

The compound f 123 mg (0.100 mmole), silver oxide (I) (Ag₂O (I)) 278 mg (1.20 mmole), the compound c 50.7 mg (0.220 mmole) and tetrahydrofuran (THF, deaerated solvent) 20 ml were put in a Schlenk bottle under argon atmosphere, and it was shielded from light with an aluminum foil and stirred under refluxing for 24 hours. The solvent component was distilled off from the reaction solution under reduced pressure, and this was refined by column chromatography using a deaerated solvent (CH₂Cl₂:hexane=2:1). As a result thereof, 82.1 mg (0.114 mmol, yield: 57.0%) of a pale yellow solid matter.

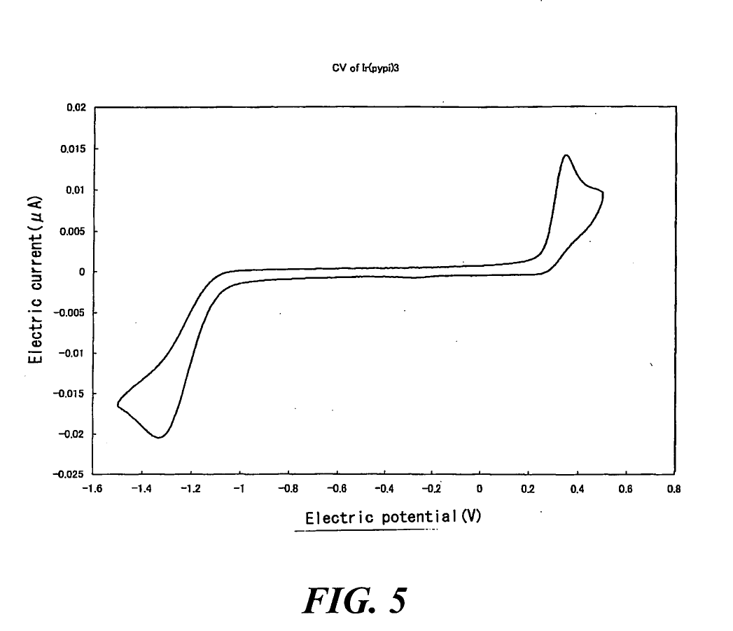

The result (refer to FIG. 5) of cyclic voltammetry and the result (refer to FIG. 6) of X-ray crystal structure analysis are shown below.

### [Measuring Result of FAB-MS]

MS (FAB⁺): m/z=722 (M⁺), 579 (M⁺-(Ligand))

[Measuring result of cyclic voltammetry (vs Ag⁺/Ag in CH₂Cl₂, apparatus: HOKUTO DENKO HSV-100)]

E^{OX}=0.35, E^{RED}=−1.33 (V)

### Example 4

### Synthesis of Transition Metal Complex Compound 2

A compound 2 was synthesized according to the following reaction step:

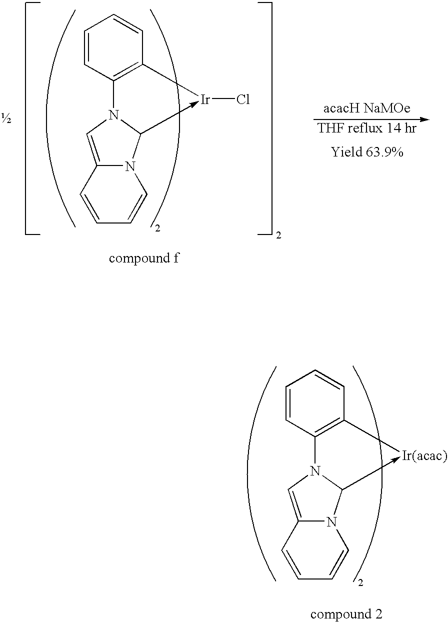

The compound f 123 mg (0.100 mmole), NaOMe 21.6 mg (0.400 mmole), acetylacetone (acach) 0.04 ml (0.40 mmole) and tetrahydrofuran (THF, deaerated solvent) 20 ml were put in a Schlenk bottle under argon atmosphere, and it was stirred under refluxing for 14 hours. The solvent component was distilled off from the reaction solution under reduced pressure to obtain a crude product (yellow solid matter). This was refined by column chromatography (developing solvent: deaerated methylene chloride). As a result thereof, 86.2 mg (0.114 mmol, yield: 63.9%) of a yellowish brown solid matter. The result of ¹H-NMR is shown below.

Compound f ¹H-NMR (CDCl₃, 300 MHz, 35° C.): δ 1.75 (s, 6H, CH₃), 5.20 (5, 1H, COCHCO), 6.14 (dd, J=7.4, 1.4 Hz, 2H, Hⁱ), 6.42 (ddd, J=7.4, 6.3, 1.1 Hz, 2H, H^{h}), 6.48 (ddd, J=7.4, 7.4, 1.0 Hz, 2H, H^{b}), 6.75 (ddd, J=7.7, 7.4, 1.1 Hz, 2H, H^{c}), 6.78 (ddd, J=9.6, 6.3, 1.4 Hz, 2H, H^{g}), 7.17 (dd, J=7.7, 1.0 Hz, 2H, H^{d}), 7.34 (d, J=9.6, 1.1 Hz, 2H, H^{f}), 7.73 (s, 2H, H^{e}), 8.26 (dd, J=7.4, 1.1 Hz, 2H, H^{a})

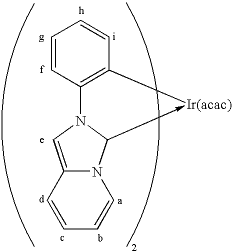

[Measuring result of EI-MS]

MS (EI⁺): m/z=678.3 (M⁺), 579.2 (M⁺-(acac))

### [Measuring Result of Cyclic Voltammetry (vs Ag⁺/Ag in CH₂Cl₂)]

E^{OX}=0.49, E^{RED}=−1.25 (V)

### [Measuring Result of Infrared Absorption Spectrum]

IR (KBr disc): ν(c=c)+ν(c=0)=1581, ν(c=c)+ν(c=0)=1518 cm⁻¹ (apparatus: Jasco FT/1R-410)

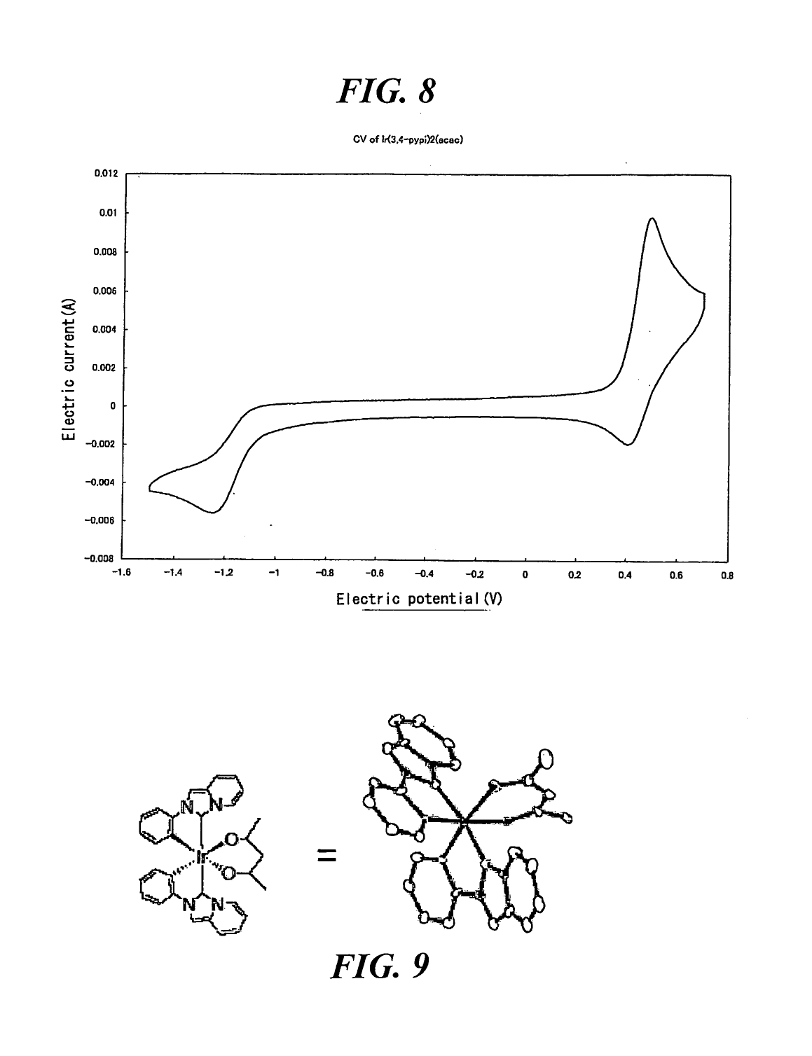

The result (refer to FIG. 7) of ¹H-NMR, the result (refer to FIG. 8) of cyclic voltammetry and the result (refer to FIG. 9) of X-ray crystal structure analysis are shown.

### INDUSTRIAL APPLICABILITY

As explained above in details, the transition metal complex compound of the present invention having a metal carbene bond has an electroluminescent characteristic and can provide an organic EL device having a high luminous efficiency. Further, according to the production process of the present invention for a transition metal complex compound, the transition metal complex compound can efficiently be produced.

What is claimed is:

1. A transition metal complex compound having a metal carbene bond represented by the following Formula (1): 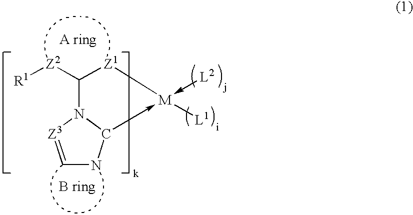
[in Formula (1), C (carbon atom)→M represents a metal carbene bond; a bond shown by a solid line (—) represents a covalent bond; a bond shown by an arrow (→) represents a coordinate bond; M represents a metal atom of iridium (Ir), platinum (Pt), rhodium (Rh) or palladium (Pd); L¹ and L² each represent independently a unidentate ligand or a cross-linked bidentate ligand (L¹-L²) in which L¹ is cross-linked with L²; k represents an integer of 1 to 3, and i represents an integer of 0 to 2; k+i represents a valence of metal M; j represents an integer of 0 to 4; when i and j are plural, L¹ and L² may be the same as or different from each other, and the adjacent ligands may be cross-linked with each other;
L¹ represents a monovalent aromatic hydrocarbon group having 6 to 30 nuclear carbon atoms which may have a substituent, a monovalent heterocyclic group having 3 to 30 nuclear carbon atoms which may have a substituent, a monovalent carboxyl-containing group having 1 to 30 carbon atoms which may have a substituent, a monovalent amino group or hydroxyl group-containing hydrocarbon group which may have a substituent, a cycloalkyl group having 3 to 50 nuclear carbon atoms which may have a substituent, an alkyl group having 1 to 30 carbon atoms which may have a substituent, an alkenyl group having 2 to 30 carbon atoms which may have a substituent or an aralkyl group having 7 to 40 carbon atoms which may have a substituent, and when L¹ is cross-linked with L², it is a divalent group of each ligand described above;
L² represents a ligand comprising a heterocycle having 3 to 30 nuclear carbon atoms which may have a substituent, carboxylic acid ester having 1 to 30 carbon atoms which may have a substituent, carboxylic amide having 1 to 30 carbon atoms, amine which may have a substituent, phosphine which may have a substituent, isonitrile which may have a substituent, ether having 1 to 30 carbon atoms which may have a substituent, thioether having 1 to 30 carbon atoms which may have a substituent or a double bond-containing compound having 1 to 30 carbon atoms which may have a substituent and when L¹ is cross-linked with L², it is a monovalent group of each ligand described above;
Z¹ represents an atom forming a covalent bond with metal M, and it is a carbon, silicon, nitrogen or phosphorus atom;
Z² represents an atom forming a covalent bond with a substituent R¹, and it is a carbon, silicon, nitrogen or phosphorus atom; an A ring containing Z¹ and Z² and a B ring represent an aromatic hydrocarbon group having 3 to 40 nuclear carbon atoms which may have a substituent or a heterocyclic group having 3 to 40 nuclear carbon atoms which may have a substituent; Z³ represents a nitrogen atom or CR², and when CR² is plural, plural R² may be the same or different;
R¹ and R² each represents independently a hydrogen atom, a halogen atom, a thiocyano group, a cyano group, a nitro group, a —S(═O)₂R¹⁸ group, a —S(═O)R¹⁸ group, an alkyl group having 1 to 30 carbon atoms which may have a substituent, a halogenated alkyl group having 1 to 30 carbon atoms which may have a substituent, an aromatic hydrocarbon group having 6 to 30 nuclear carbon atoms which may have a substituent, a cycloalkyl group having 3 to 30 nuclear carbon atoms which may have a substituent, an aralkyl group having 7 to 40 carbon atoms which may have a substituent, an alkenyl group having 2 to 30 carbon atoms which may have a substituent, a heterocyclic group having 3 to 30 nuclear carbon atoms which may have a substituent, an alkoxy group having 1 to 30 carbon atoms which may have a substituent, an aryloxy group having 6 to 30 nuclear carbon atoms which may have a substituent, an alkylamino group having 3 to 30 nuclear carbon atoms which may have a substituent, an arylamino group having 6 to 30 carbon atoms which may have a substituent, an alkylsilyl group having 3 to 30 nuclear carbon atoms which may have a substituent, an arylsilyl group having 6 to 30 carbon atoms which may have a substituent or a carboxyl-containing group having 1 to 30 carbon atoms, and when Z³ is CR², R¹ may be cross-linked with R²;
(R¹⁸ each represents independently a hydrogen atom, an alkyl group having 1 to 30 carbon atoms which may have a substituent, a halogenated alkyl group having 1 to 30 carbon atoms which may have a substituent, an aromatic hydrocarbon group having 6 to 30 nuclear carbon atoms which may have a substituent, a cycloalkyl group having 3 to 50 nuclear carbon atoms which may have a substituent, an aralkyl group having 7 to 40 carbon atoms which may have a substituent, an alkenyl group having 2 to 30 carbon atoms which may have a substituent, a heterocyclic group having 3 to 30 nuclear carbon atoms which may have a substituent, an alkoxy group having 1 to 30 carbon atoms which may have a substituent, an aryloxy group having 6 to 30 nuclear carbon atoms which may have a substituent, an alkylamino group having 3 to 30 carbon atoms which may have a substituent, an arylamino group having 6 to 30 carbon atoms which may have a substituent, an alkylsilyl group having 3 to 30 carbon atoms which may have a substituent, an arylsilyl arylsilyl group having 6 to 30 carbon atoms which may have a substituent or a carboxyl-containing group having 1 to 30 carbon atoms which may have a substituent);
when k is plural, Z¹, Z², Z³, R¹, the A ring and the B ring may be the same as or different from each other and may be cross-linked with adjacent ones).

2. The transition metal complex compound having a metal carbene bond as described in claim 1, wherein M described above is Ir.

3. The transition metal complex compound having a metal carbene bond as described in claim 1, represented by the following Formula (2): 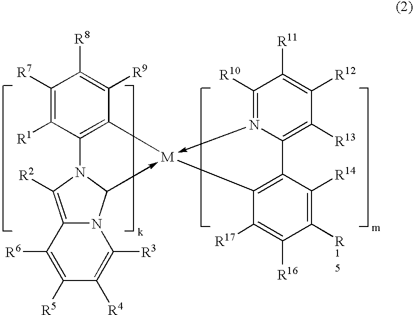
[in Formula (2), C (carbon atom)→M represents a metal carbene bond; R¹, R², M and k each are the same as described above; m is an integer of 0 to 2, and k+m represents a valence of metal M;
R³ to R¹⁷ each represent independently a hydrogen atom, a halogen atom, a thiocyano group, a cyano group, a nitro group, a —S(═O)₂R¹⁸ group, a —S(═O)R¹⁸ group (R¹⁸ is the same as described above), an alkyl group having 1 to 30 carbon atoms which may have a substituent, a halogenated alkyl group having 1 to 30 carbon atoms which may have a substituent, an aromatic hydrocarbon group having 6 to 30 nuclear carbon atoms which may have a substituent, a cycloalkyl group having 3 to 30 nuclear carbon atoms which may have a substituent, an aralkyl group having 7 to 40 carbon atoms which may have a substituent, an alkenyl group having 2 to 30 carbon atoms which may have a substituent, a heterocyclic group having 3 to 30 nuclear carbon atoms which may have a substituent, an alkoxy group having 1 to 30 carbon atoms which may have a substituent, an aryloxy group having 6 to 30 nuclear carbon atoms which may have a substituent, an alkylamino group having 3 to 30 nuclear carbon atoms which may have a substituent, an arylamino group having 6 to 30 carbon atoms which may have a substituent, an alkylsilyl group having 3 to 30 nuclear carbon atoms which may have a substituent, an arylsilyl group having 6 to 30 carbon atoms which may have a substituent or a carboxyl-containing group having 1 to 30 carbon atoms, and R³ to R¹⁷ may be cross-linked with adjacent ones.

4. The transition metal complex compound having a metal carbene bond as described in claim 3, wherein M described above is Ir.

5. A transition metal complex compound having a metal carbene bond represented by the following Formula (3): 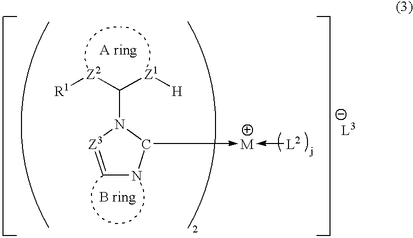
[in Formula (3), C (carbon atom)→M represents a metal carbene bond, and a bond shown by an arrow represents a coordinate bond; M represents a metal atom of iridium (Ir), platinum (Pt), rhodium (Rh) or palladium (Pd); L² represents a unidentate ligand; j represents an integer of 0 to 4; and when j is plural, respective L² may be the same as or different from each other and may be cross-linked;
L² represents a ligand comprising a heterocycle having 3 to 30 nuclear carbon atoms which may have a substituent, carboxylic acid ester having 1 to 30 carbon atoms which may have a substituent, carboxylic amide having 1 to 30 carbon atoms, amine which may have a substituent, phosphine which may have a substituent, isonitrile which may have a substituent, ether having 1 to 30 carbon atoms which may have a substituent, thioether having 1 to 30 carbon atoms which may have a substituent or a double bond-containing compound having 1 to 30 carbon atoms which may have a substituent;
L³ represents a conjugated base of superstrong acids having a pKa value of −10 or less, carboxylic acids, aldehydes, ketones, alcohols, thioalcohols, phenols, amines, amides, aromatics or alkanes, a hydrogen ion or a halide ion;
Z¹ represents a carbon, silicon, nitrogen or phosphorus atom; Z² represents an atom forming a covalent bond with a substituent R¹, and it is a carbon, silicon, nitrogen or phosphorus atom; an A ring containing Z¹ and Z² and a B ring represent an aromatic hydrocarbon group having 3 to 40 nuclear carbon atoms which may have a substituent or a heterocyclic group having 3 to 40 nuclear carbon atoms which may have a substituent; Z³ represents a nitrogen atom or CR², and when CR² is plural, plural R² may be the same or different;
R¹ and R² each represent independently a hydrogen atom, a halogen atom, a thiocyano group, a cyano group, a nitro group, a —S(═O)₂R¹⁸ group, a —S(═O)R¹⁸ group, an alkyl group having 1 to 30 carbon atoms which may have a substituent, a halogenated alkyl group having 1 to 30 carbon atoms which may have a substituent, an aromatic hydrocarbon group having 6 to 30 nuclear carbon atoms which may have a substituent, a cycloalkyl group having 3 to 30 nuclear carbon atoms which may have a substituent, an aralkyl group having 7 to 40 carbon atoms which may have a substituent, an alkenyl group having 2 to 30 carbon atoms which may have a substituent, a heterocyclic group having 3 to 30 nuclear carbon atoms which may have a substituent, an alkoxy group having 1 to 30 carbon atoms which may have a substituent, an aryloxy group having 6 to 30 nuclear carbon atoms which may have a substituent, an alkylamino group having 3 to 30 nuclear carbon atoms which may have a substituent, an arylamino group having 6 to 30 carbon atoms which may have a substituent, an alkylsilyl group having 3 to 30 nuclear carbon atoms which may have a substituent, an arylsilyl group having 6 to 30 carbon atoms which may have a substituent or a carboxyl-containing group having 1 to 30 carbon atoms, and when Z³ is CR², R¹ may be cross-linked with R²;
(R¹⁸ each represents independently a hydrogen atom, an alkyl group having 1 to 30 carbon atoms which may have a substituent, a halogenated alkyl group having 1 to 30 carbon atoms which may have a substituent, an aromatic hydrocarbon group having 6 to 30 nuclear carbon atoms which may have a substituent, a cycloalkyl group having 3 to 50 nuclear carbon atoms which may have a substituent, an aralkyl group having 7 to 40 carbon atoms which may have a substituent, an alkenyl group having 2 to 30 carbon atoms which may have a substituent, a heterocyclic group having 3 to 30 nuclear carbon atoms which may have a substituent, an alkoxy group having 1 to 30 carbon atoms which may have a substituent, an aryloxy group having 6 to 30 nuclear carbon atoms which may have a substituent, an alkylamino group having 3 to 30 carbon atoms which may have a substituent, an arylamino group having 6 to 30 carbon atoms which may have a substituent, an alkylsilyl group having 3 to 30 carbon atoms which may have a substituent, an arylsilyl group having 6 to 30 carbon atoms which may have a substituent or a carboxyl-containing group having 1 to 30 carbon atoms which may have a substituent);
Z¹, Z², Z³, R¹, the A ring and the B ring which are two respectively may be the same as or different from each other and may be cross-linked with adjacent ones].

6. The transition metal complex compound having a metal carbene bond as described in claim 5, wherein M described above is Ir.

7. A transition metal complex compound having a metal carbene bond represented by the following Formula (4): 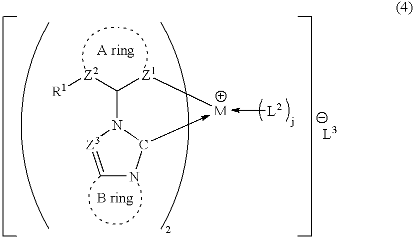
[in Formula (4), C (carbon atom)→M represents a metal carbene bond; a bond shown by a solid line (—) represents a covalent bond; a bond shown by an arrow (→) represents a coordinate bond; M represents a metal atom of iridium (Ir), platinum (Pt), rhodium (Rh) or palladium (Pd); L² represents a unidentate ligand; j represents an integer of 0 to 4; and when j is plural, respective L² may be the same as or different from each other and may be cross-linked;
L² represents a ligand comprising a heterocycle having 3 to 30 nuclear carbon atoms which may have a substituent, carboxylic acid ester having 1 to 30 carbon atoms which may have a substituent, carboxylic amide having 1 to 30 carbon atoms, amine which may have a substituent, phosphine which may have a substituent, isonitrile which may have a substituent, ether having 1 to 30 carbon atoms which may have a substituent, thioether having 1 to 30 carbon atoms which may have a substituent or a double bond-containing compound having 1 to 30 carbon atoms which may have a substituent, and when L¹ is cross-linked with L², it is a monovalent group of each ligand described above;
L³ represents a conjugated base of superstrong acids having a pKa value of −10 or less, carboxylic acids, aldehydes, ketones, alcohols, thioalcohols, phenols, amines, amides, aromatics or alkanes, a hydrogen ion or a halide ion;
Z¹ represents an atom forming a covalent bond with metal M, and it is a carbon, silicon, nitrogen or phosphorus atom;
Z² represents an atom forming a covalent bond with a substituent R¹, and it is a carbon, silicon, nitrogen or phosphorus atom; an A ring containing Z¹ and Z² and a B ring represent an aromatic hydrocarbon group having 3 to 40 nuclear carbon atoms which may have a substituent or a heterocyclic group having 3 to 40 nuclear carbon atoms which may have a substituent; Z³ represents a nitrogen atom or CR², and when CR² is plural, plural R² may be the same or different;
R¹ and R² each represent independently a hydrogen atom, a halogen atom, a thiocyano group, a cyano group, a nitro group, a —S(═O)₂R¹⁸ group, a —S(═O)R¹⁸ group, an alkyl group having 1 to 30 carbon atoms which may have a substituent, a halogenated alkyl group having 1 to 30 carbon atoms which may have a substituent, an aromatic hydrocarbon group having 6 to 30 nuclear carbon atoms which may have a substituent, a cycloalkyl group having 3 to 30 nuclear carbon atoms which may have a substituent, an aralkyl group having 7 to 40 carbon atoms which may have a substituent, an alkenyl group having 2 to 30 carbon atoms which may have a substituent, a heterocyclic group having 3 to 30 nuclear carbon atoms which may have a substituent, an alkoxy group having 1 to 30 carbon atoms which may have a substituent, an aryloxy group having 6 to 30 nuclear carbon atoms which may have a substituent, an alkylamino group having 3 to 30 nuclear carbon atoms which may have a substituent, an arylamino group having 6 to 30 carbon atoms which may have a substituent, an alkylsilyl group having 3 to 30 nuclear carbon atoms which may have a substituent, an arylsilyl group having 6 to 30 carbon atoms which may have a substituent or a carboxyl-containing group having 1 to 30 carbon atoms, and when Z³ is CR², R¹ may be cross-linked with R²;
(R¹⁸ each represents independently a hydrogen atom, an alkyl group having 1 to 30 carbon atoms which may have a substituent, a halogenated alkyl group having 1 to 30 carbon atoms which may have a substituent, an aromatic hydrocarbon group having 6 to 30 nuclear carbon atoms which may have a substituent, a cycloalkyl group having 3 to 50 nuclear carbon atoms which may have a substituent, an aralkyl group having 7 to 40 carbon atoms which may have a substituent, an alkenyl group having 2 to 30 carbon atoms which may have a substituent, a heterocyclic group having 3 to 30 nuclear carbon atoms which may have a substituent, an alkoxy group having 1 to 30 carbon atoms which may have a substituent, an aryloxy group having 6 to 30 nuclear carbon atoms which may have a substituent, an alkylamino group having 3 to 30 carbon atoms which may have a substituent, an arylamino group having 6 to 30 carbon atoms which may have a substituent, an alkylsilyl group having 3 to 30 carbon atoms which may have a substituent, an arylsilyl group having 6 to 30 carbon atoms which may have a substituent or a carboxyl-containing group having 1 to 30 carbon atoms which may have a substituent);
Z¹, Z² , Z³, R¹, the A ring and the B ring which are two respectively may be the same as or different from each other and may be cross-linked with adjacent ones].

8. The transition metal complex compound having a metal carbene bond as described in claim 7, wherein M described above is Ir.

9. A production process for a transition metal compound having a metal carbene bond comprising reacting an iridium compound represented by the following Formula (5) with an imidazolium salt represented by the following Formula (6) in the presence of a solvent and a base to produce a transition metal compound represented by Formula (7): 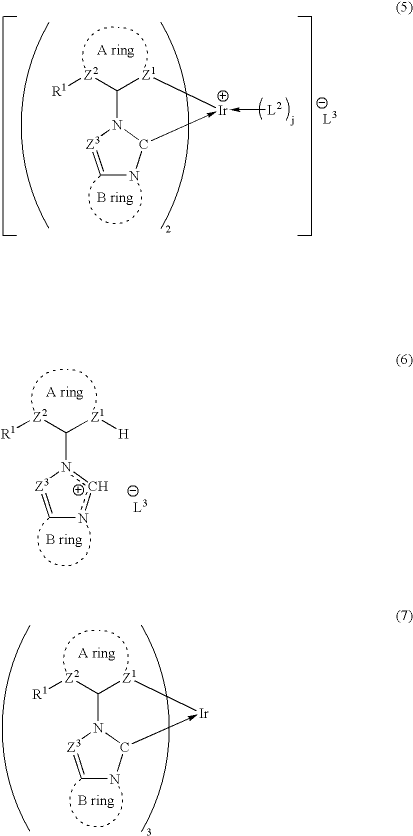
[in Formulas (5) to (7), C (carbon atom)→Ir (iridium) represents a metal carbene bond; a bond shown by a solid line (—) represents a covalent bond; a bond shown by an arrow (→) represents a coordinate bond; L² represents a unidentate ligand; j represents an integer of 0 to 4; when j is plural, respective L² may be the same as or different from each other and may be cross-linked;
L² represents a ligand comprising a heterocycle having 3 to 30 nuclear carbon atoms which may have a substituent, carboxylic acid ester having 1 to 30 carbon atoms which may have a substituent, carboxylic amide having 1 to 30 carbon atoms, amine which may have a substituent, phosphine which may have a substituent, isonitrile which may have a substituent, ether having 1 to 30 carbon atoms which may have a substituent, thioether having 1 to 30 carbon atoms which may have a substituent or a double bond-containing compound having 1 to 30 carbon atoms which may have a substituent, and when L¹ is cross-linked with L², it is a monovalent group of each ligand described above;
L³ represents a conjugated base of superstrong acids having a pKa value of −10 or less, carboxylic acids, aldehydes, ketones, alcohols, thioalcohols, phenols, amines, amides, aromatics or alkanes, a hydrogen ion or a halide ion;
Z¹ represents an atom forming a covalent bond with metal M, and it is a carbon, silicon, nitrogen or phosphorus atom;
Z² represents an atom forming a covalent bond with a substituent R¹, and it is a carbon, silicon, nitrogen or phosphorus atom; an A ring containing Z¹ and Z² and a B ring represent an aromatic hydrocarbon group having 3 to 40 nuclear carbon atoms which may have a substituent or a heterocyclic group having 3 to 40 nuclear carbon atoms which may have a substituent; Z³ represents a nitrogen atom or CR², and when CR² is plural, plural R² may be the same or different;
R¹ and R² each represent independently a hydrogen atom, a halogen atom, a thiocyano group, a cyano group, a nitro group, a —S(═O)₂R¹⁸ group, a —S(═O)R¹⁸ group, an alkyl group having 1 to 30 carbon atoms which may have a substituent, a halogenated alkyl group having 1 to 30 carbon atoms which may have a substituent, an aromatic hydrocarbon group having 6 to 30 nuclear carbon atoms which may have a substituent, a cycloalkyl group having 3 to 30 nuclear carbon atoms which may have a substituent, an aralkyl group having 7 to 40 carbon atoms which may have a substituent, an alkenyl group having 2 to 30 carbon atoms which may have a substituent, a heterocyclic group having 3 to 30 nuclear carbon atoms which may have a substituent, an alkoxy group having 1 to 30 carbon atoms which may have a substituent, an aryloxy group having 6 to 30 nuclear carbon atoms which may have a substituent, an alkylamino group having 3 to 30 nuclear carbon atoms which may have a substituent, an arylamino group having 6 to 30 carbon atoms which may have a substituent, an alkylsilyl group having 3 to 30 nuclear carbon atoms which may have a substituent, an arylsilyl group having 6 to 30 carbon atoms which may have a substituent or a carboxyl-containing group having 1 to 30 carbon atoms, and when Z³ is CR², R¹ may be cross-linked with R²;
(R¹⁸ each represents independently a hydrogen atom, an alkyl group having 1 to 30 carbon atoms which may have a substituent, a halogenated alkyl group having 1 to 30 carbon atoms which may have a substituent, an aromatic hydrocarbon group having 6 to 30 nuclear carbon atoms which may have a substituent, a cycloalkyl group having 3 to 50 nuclear carbon atoms which may have a substituent, an aralkyl group having 7 to 40 carbon atoms which may have a substituent, an alkenyl group having 2 to 30 carbon atoms which may have a substituent, a heterocyclic group having 3 to 30 nuclear carbon atoms which may have a substituent, an alkoxy group having 1 to 30 carbon atoms which may have a substituent, an aryloxy group having 6 to 30 nuclear carbon atoms which may have a substituent, an alkylamino group having 3 to 30 carbon atoms which may have a substituent, an arylamino group having 6 to 30 carbon atoms which may have a substituent, an alkylsilyl group having 3 to 30 carbon atoms which may have a substituent, an arylsilyl group having 6 to 30 carbon atoms which may have a substituent or a carboxyl-containing group having 1 to 30 carbon atoms which may have a substituent);
Z¹, Z², Z³, R¹, the A ring and the B ring which are two respectively may be the same as or different from each other and may be cross-linked with adjacent ones].

10. The production process for a transition metal compound having a metal carbene bond as described in claim 9, wherein the solvent described above is a tetrahydrofuran derivative.

11. An organic electroluminescent device in which an organic thin film layer comprising a single layer or plural layers having at least a luminescent layer is interposed between an anode and a cathode, wherein at least one layer in the organic thin film layer contains the transition metal complex compound having a metal carbene bond as described in claim 1, 5 or 7.

12. The organic electroluminescent device as described in claim 11, wherein the luminescent layer described above contains the transition metal complex compound having a metal carbene bond as described in claim 1, 5 or 7 as a luminescent material.

13. The organic electroluminescent device as described in claim 11, wherein the luminescent layer described above contains the transition metal complex compound having a metal carbene bond as described in claim 1, 5 or 7 as a dopant.

14. The organic electroluminescent device as described in claim 11, wherein an electron injecting layer and/or an electron transporting layer is provided between the luminescent layer and the cathode described above, and the above electron injecting layer and/or electron transporting layer comprises a π-electron deficient nitrogen-containing heterocyclic derivative as a principal component.

15. The organic electroluminescent device as described in claim 11, wherein a reducing dopant is added to an interracial region between the cathode and the organic thin film layer described above
